(19) United States
(12) Patent Application Publication
(10) Pub. No.: US 2010/0099875 A1
(43) Pub. Date: Apr. 22, 2010

(54) NEW ORTHO-FUNCTIONALIZED P-CHIRAL ARYLPHOSPHINES AND DERIVATIVES: THEIR PREPARATION AND USE IN ASYMMETRIC CATALYSIS

(75) Inventors: Michel Stephan, Vanves (FR); Barbara Mohar, Grosuplje (SI)

Correspondence Address: Phosphoenix Sarl, 115, Rue De L'abbe Groult, Paris, F-75015, FR

(73) Assignees: PHOSPHOENIX SARL, Paris (FR); NATIONAL INSTITUTE OF CHEMISTRY, Ljubljana (SI)

(21) Appl. No.: 11/993,408

(22) PCT Filed: Jun. 20, 2006
(86) PCT No.: PCT/FR2006/001394

§ 371 Date: Dec. 31, 2009

(30) Foreign Application Priority Data
Jun. 20, 2005 (FR) 0506226

(51) Int. Cl. C07F 9/02; C07F 9/28; C07F 15/00; C07F 1/00

(52) U.S. Cl. 546/21; 568/2; 549/220; 549/214; 548/412; 556/136; 556/138; 556/110

(57) ABSTRACT

The invention relates to novel organo phosphorus P-chiral optically active compounds of formula (I) having a hydroxyl, mercapto, amino, carboxyl, sulfonyl group on aryl near a phosphorus atom, to the preparation and the use thereof in then asymmetrical catalysis of unsaturated compounds. Novel acylphosphine optically pure ligands embodied in the form of transition metal complexes exhibit an increased activity and enantloselectivity, in particular in asymmetrical hydrogenation, in comparison with the same type Uganda such as DiPAMP.

The present invention concerns new optically active P-chiral phosphines, their precursors and their derivatives where the phosphorus atom is a bearer of chirality and of a (hetero)aryl group functionalized in 2- or ortho-position; their preparation, the preparation of their metal complexes, and their application in asymmetric catalysis involving unsaturated compounds. This technology allows easy access to enantiomers of chiral molecules interesting in particular the pharma, agrochemical, food, and cosmetic industries.

New series of optically pure P-chiral arylphosphines, their precursors and their derivatives, possessing on the aryl in the proximity of the phosphorus atom a hydroxy-, amino- or carboxy-group, were prepared in their enantiomerically pure forms in good yields. They were easily modified in one step giving rise to a wide diversity of P-homochiral analogues. The new phosphines are easily handled due to their good air/moisture stability. In the form of their transition metal complexes, a wide variety among them exhibit superior activity and enantioselectivity in asymmetric catalysis, especially in hydrogenation, compared to well-established ligands of their type as Nobel co-laureate Knowles bis(o-anisylphenyl-phosphino)ethane (DiPAMP) ligand. For example, the asymmetric hydrogenation of itaconic acid under 1 bar of H₂ with rhodium-DiPAMP complex leads to 11% enantiomeric excess (ee) and 40% conversion in 1 hour while with the new ligands of the invention, a 98.5% ee and 100% conversion were reached in 6 minutes. Consequently, the access to such a broad variety of active P-chiral phosphine ligands from a common structure, permits fine-tuning of the catalyst for a given application, a reduced amount of the catalyst is needed, and the desired molecules are obtained at a faster rate and with higher optical purity.

Catalysis mediated by transition-metal complexes of optically active phosphine ligands is an interesting technology for the synthesis and production of enantiomers of chiral molecules. Despite all strides, still no universal phosphine exists for the sought C═C, C═O, and C═N bond transformation reactions requiring cost-effective catalysts which possess high activity and attain 100% enantioselectivity. The known syntheses of efficient ligands are either restricted to the access to one antipode (e.g. ^{t}BuBisP*, MiniPHOS, TangPHOS), not trivial (e.g. DuPHOS-type ligands, NORPHOS, PhanePHOS), or a multistep synthesis is required for the preparation of a new modified parent diphosphine with different substituents either on the phosphorus atom or at the backbone.

It has been found that a close proximity of the chirality of the ligand to the catalyst metal center increases stereoselectivity. Amongst the existing phosphines, the P-chiral ones are rare and few research groups have been involved in their preparation (Mislow et al, J. Am. Chem. Soc. 1968, 90(18), 4842-4846; Knowles, Angew. Chem. Int. Ed. 2002, 41, 1998-2007; Imamoto et al, J. Am. Chem. Soc. 1990, 112, 5244-5252; Eur. J. Org. Chem. 2002, 2535-2546; Jugé et al, Tetrahedron Lett. 1990, 31(44), 6357-6360; FR 91/01674; WO 91/00286; Brown et al, Tetrahedron 1990, 46(13/14), 4877-4886; J. Chem. Soc., Perkin Trans. 1 1993, 831-839). In general, optically pure P-chiral phosphines could be prepared either according to Mislow or to Imamoto procedures through the separation of diastereomeric phosphinate or phosphinite-borane intermediates, respectively. In particular, the asymmetric strategy relying on the use of a chiral inductor derived from an aminoalcohol as (+)- or (−)-ephedrine developed by Jugé et al and by Brown et al proved to be advantageous for the practical preparation of both enantiomers of several P-chiral phosphines. However, still the synthesis of a new modified parent phosphine requires several steps starting from a common intermediate.

Following the results of his assessment tests of a variety of ortho-functionalized mono- and di-arylphosphines, Knowles has emphasized on the importance of the o-anisyl group in DiPAMP to attain high enantioselectivity (Advances in Chemistry 1982, 196, Catalysis Aspects Met. Phosphine Complexes, 325-336). However since then, no conclusive work based on a structural modification of its methoxy group has been undertaken. Also, few modifications were carried out to replace the o-anisyl group by other groups. As described within this invention, a striking improvement in activity and stereoselectivity was obtained by the appropriate modification of the methyl of the methoxy group. This result shows that the chiral induction is not only influenced by the methoxy group but more importantly by the bulkiness—and probably by the electronic structure—of the substituent of its oxygen atom.

In 1982, Knowles prepared (R,R)-bis(o-hydroxyphenyl-phenylphosphino)ethane by demethylation of (R,R)-DiPAMP with Ph₂PLi. The results of its use and the use of its acylated derivative in asymmetric hydrogenation were not better than those obtained with the mother ligand DiPAMP. Also in 2001, Pizzano and Suarez prepared (S)-o-(methylphenyl-phosphino)phenol by demethylation of commercially available (S)-phenyl-o-anisylmethyl-phosphine (PAMP), using BBr₃ followed by a basic workup. Phosphine-phosphites were prepared by coupling it with chlorophosphites (Tetrahedron: Asymm 2001, 12, 2501-2504). However, the attempts of the present inventors to functionalize the hydroxy group of the demethylated PAMP with activated alkyls (addition of 1 equivalent ⁱPrI) failed but yielded instead impure phosphonium salts as shown by ¹H and ³¹P NMR. Also, Jugé et al prepared chiral 2-hydroxyphenyl and 2-hydroxynaphth-1-yl substituted phosphine-boranes through Fries type rearrangement of the corresponding 2-(1-bromoaryl) phosphinite-borane (Tetrahedron: Asymm 2000, 11(19), 3939-3956). However, this route is not general for the preparation of optically pure ortho-functionalized P-chiral arylphosphines and has a major drawback for the preparation of optically pure ortho-functionalized DiPAMP-type diphosphines due to decrease in optical purity in the preparation of the required o-(methylphenylphosphino-borane)phenol intermediate for their synthesis.

Our invention concerns the synthesis of optically active—more particularly with 95% optical purity—P-chiral arylphosphines functionalized in 2- or ortho-position, of their precursors and derivatives of general formula (I). It concerns as well the preparation and the use of their metal complexes in asymmetric catalysis.

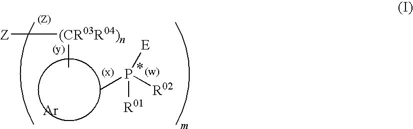

wherein:
m is an integer higher or equal to 1, n is a number equal to 0 or 1,
P* symbolizes an asymmetric phosphorus atom; with m>1, the P* atoms have preferentially the same absolute configuration,
E represents an electron pair (2e⁻), a borane (BH₃), or an acid such as HBF₄, TfOH, HClO₄, HPF₆, HBr, HI, HCl, HF, AcOH, CF₃CO₂H, MsOH,
R⁰³ and R⁰⁴ represent independently from one another a hydrogen atom, a C₁₋₄ alkyl or C₁₋₄ alkoxy group optionally substituted with F atoms, and/or with other C₁₋₄ alkyl or alkoxy groups also optionally substituted; or may be linked together to form a ring as a C₅₋₆ cycloalkane, a dioxolane, a dioxane, or bonded to Ar to form for example a naphth-1,8-diyl optionally substituted;
(z) indicates the bond established between the group (CR⁰³R⁰⁴)ₙ and Z, and when n=0, then (y) indicates the bond established between Ar and Z,
Ar symbolizes a C₄₋₁₄ aromatic or polyaromatic group linked to P* atom by (x) bond and to Z—(CR⁰³R⁰⁴)ₙ group by (y) bond in such a way that the Z—(CR⁰³R⁰⁴)ₙ group is in 2- or ortho-position to the P* atom; Ar includes or not one or several heteroatoms such as N, O, S, or may optionally bear one or several heteroatoms such as N, O, Si, halogen, and/or Ar may be optionally substituted with one or several C₁₋₁₀ alkyls and/or alkoxys also optionally substituted or forming a cycle between themselves; in such a way that the phosphino-Ar may represent a phosphinobenzene, 1-phosphinonaphthalene, 2-phosphinonaphthalene, N—(R⁰⁵)-2-methyl-7-phosphinoindole, N—(R⁰⁵)-7-phosphinoindoline, or Z—(CR⁰³R⁰⁴)ₙ—Ar-phosphino may represent a N—(R⁰⁵)-2-phosphinopyrrole or N—(R⁰⁵)-2-phosphinoindole, wherein N—(R⁰⁵) represents a nitrogen atom linked to a hydrogen, a C₆₋₁₄ aryl group as 1-naphthyl optionally substituted, a C₁₋₁₈ alkyl, an aryl-alkyl or alkoxycarbonyl as tert-butoxycarbonyl, optionally substituted with alkyls, alkoxys and/or heteroatoms such as N, P or F; for example, Z—(CR⁰³R⁰⁴)ₙ)—Ar may represent a 2-hydroxyphenyl, 1-naphthol-2-yl, 2-naphthol-1-yl, 2-R⁰⁵O-phenyl, 1-R⁰⁵O-naphth-2-yl, 2-R⁰⁵O-naphth-1-yl, thiophenol-2-yl, 2-(thio-isopropoxy)phenyl, 2-(thio-tert-butoxy)phenyl, 2-(2′-propanesulfonyl)phenyl, 2-(tert-butylsulfonyl)phenyl, 2-(hydroxymethyl)phenyl, 2-(R⁰⁵O-methyl)phenyl, 2-(N,N-diisopropylaminomethyl)phenyl, 2-(N,N-dicyclohexylaminomethyl)phenyl, 2-(N,N-diisopropylamido)phenyl, N—(R⁰⁵)-2-methyl-indol-7-yl, N—(R⁰⁵)-indolin-7-yl, N—(R⁰⁵)-pyrrol-2-yl, N—(R⁰⁵)-indol-2-yl, wherein R⁰⁵ is as defined below,
Z represents a group such as OR⁰⁵, SR⁰⁵, SO₂R⁰⁵, N(R⁰⁶R⁰⁷), C(O)N(R⁰⁶R⁰⁷), or N—(R⁰⁵), and with m=1, (CR⁰³R⁰⁴)ₙ═CH₂, Z may represent a branched C₅₋₇ alkyl or cycloalkyl optionally substituted with C₁₋₁₀ alkyls or C₅₋₁₄ aryls; or also may represent a C₁₋₁₀ trialkylsilyl group, triphenylsilyl, a C₅₋₁₄ (hetero) aryl, optionally substituted with F atoms or C₁₋₁₀ alkyls,
with m≧2, Z may represent a R⁰⁵ group linked at end-of-chain(s) to O-, S-, N-, NC(O)-termini, optionally interrupted by heteroatoms such as N, O, S, Si, P; or also R⁰⁵ may represent a chiral hydrocarbon chain, a polymer, a resin, a gel, a siloxane, or a spacer between these and the O-, S-, N-, NC(O)-termini; for instance R⁰⁵ may represent a skeleton of formula (II),

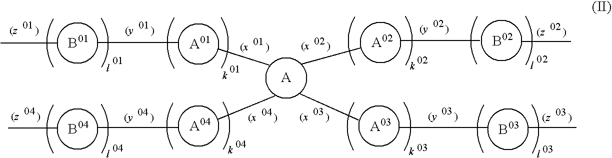

wherein:
A symbolizes a carbon, O, or S atom or a Ts-N, CH, CH₂, (—Si(R⁰⁵′)₂O—Si(R⁰⁵′)₂)_{m′} group, an arene as benzene, pyridine, wherein R⁰⁵′ represents a C₁₋₁₀ alkyl and m′ is an integer higher or equal to 1,
A⁰¹, A⁰², A⁰³, A⁰⁴ independently from one another symbolize a CH₂, or (R⁰⁵′)CH wherein R⁰⁵′ represents a C₁₋₁₀ alkyl,
B⁰¹, B⁰², B⁰³, B⁰⁴ independently from one another symbolize a CH₂, C(O), SO₂, (R⁰⁸R⁰⁹)Si, C(O)N, C(O)O, wherein R⁰⁸ and R⁰⁹ represent independently from one another a C₁₋₁₈ alkyl, a C₅₋₈ cycloalkyl or C₆₋₁₀ aryl, optionally substituted with alkyls, alkenyls or aryls, and/or contain heteroatoms as O, N, Si, P, halogen,
k⁰¹, k⁰², k⁰³, k⁰⁴ independently from one another are integers varying from zero to 10, and l⁰¹, l⁰², l⁰³, l⁰⁴ are independently from one another integers varying from zero to 1,
(x⁰¹), (x⁰²), (x⁰³), (x⁰⁴) indicate the bond established respectively between A and A^{01, A}⁰², A⁰³, A⁰⁴, and when k⁰¹, k⁰², k⁰³ or k⁰⁴ equals zero, then (x⁰¹), (x⁰²), (x⁰³), (x⁰⁴) indicate the bond established respectively between A and B⁰¹, B⁰², B⁰³, B⁰⁴,
(y⁰¹), (y⁰²), (y⁰³), (y⁰⁴) indicate the bonds established respectively between A⁰¹, A⁰², A⁰³, A⁰⁴ and B⁰¹, B⁰², B⁰³, B⁰⁴,
(Z⁰¹), (Z⁰²), (Z⁰³), (Z⁰⁴) indicate the bonds established respectively between B⁰¹, B⁰², B⁰³, B⁰⁴ and the O-, S-, N-, NC(O)-termini, and when l⁰¹, l⁰², l⁰³ or l⁰⁴ equals zero, then (y⁰¹), (y⁰²), (y⁰³), (y⁰⁴) indicate the bonds established respectively between A⁰¹, A⁰², A⁰³, A⁰⁴ and the O-, S-, N-, NC(O)-termini, and when k⁰¹ and l⁰¹, k⁰² and l⁰², k⁰³ and l⁰³, or k⁰⁴ and l⁰⁴ equal zero, then (x⁰¹), (x⁰²), (x⁰³), (x⁰⁴) indicate the bonds established between A and the O-, S-, N-, NC(O)-termini; for example, with m≧2, R⁰⁵ may be a Merrifield or a Wang resin, a (CH₂)₂, (CH₂)₃, (—CH₂CH₂)₂O, (—CH₂CH₂)₂NTs, α,α′-o-xylyl, 2,6-bis(methylene)pyridine, 1,2,4,5-(tetramethylene)benzene, diglycolyl, phthaloyl, trimesoyl, 2,6-(pyridine)dicarbonyl, (benzene)disulfonyl, 1,2-bis(dialkylsilyl)ethane, bis(dialkylsilyl)oxy,
   with m=1:
OR⁰⁵ represents a negatively charged oxygen atom, a hydroxy, a C₁₋₁₈ alkoxy, straight or branched, cyclic or polycyclic, saturated or unsaturated, optionally substituted with one or several C₄₋₁₄ (hetero) aryls—all these groups possess or not one or several asymmetric carbon atoms symbolized by C*; or also OR⁰⁵ represents a C₅₋₁₄ (hetero) aryloxy optionally containing F atoms, one or several nitro, cyano, trifluoromethyl groups and the like; R⁰⁵ optionally substituted with heteroatoms such as O, N, Si, halogen as F, and/or functional groups such an unsaturation, a hydroxy, amino, (di)alkylamino, carboxy, ester, amide, ammonium, sulfonate, sulfate, phosphite, phosphonate, phosphate, phosphine or their derivatives; OR⁰⁵ represents also a C₁₋₃₆ acyloxy, a C₄₋₁₄ (hetero) aroyloxy, optionally chiral and/or substituted by heteroatoms and/or alkyls; or OR⁰⁵ represents a silyloxy group, a sulfate or sulfonate containing an alkyl, aryl or heteroaryl optionally substituted with F, O, N atoms, or with alkyls and/or aryls; or also OR⁰⁵ (chiral or not) represents a phosphinite, phosphonite, phosphate, phosphite, phosphinate, phosphonate, borate, urethane or sulfamic ester; for example, R⁰⁵ may be an isopropyl, iso-, sec-, or tert-butyl, 3-pentyl, neopentyl, 2-methyl-but-3-yl, C₃₋₉ (cycloalkyl)methyl or cycloalkyl, 7-norbomadienyl, 7-norbornenyl, 7-norbornyl, allyl, methylallyl, 2-(alkoxycarbonyl)allyl, cyclohexene-3-yl, propargyl, methoxymethyl (MOM), (2-methoxyethoxy)methyl (MEM), 2-(trimethylsilyl)ethoxymethyl (SEM), 2-methoxyethyl, α-tetrahydropyranyl, arabino-, gluco-, or galacto-pyranosyl and acylated derivatives, glycidyl, (trimethylsilyl)methyl, bis(trimethylsilyl)methyl, 1-(trifluoromethyl)ethyl, a —(CH₂)_{m′}—R_{f} group (wherein m′=1, 2 or 3, R_{f} is a C₁₋₁₀ perfluoroalkyl), 2,2-dimethyl-1,3-dioxolane-4-methylene, bisprotected alanine-(β-yl, benzyl, pentafluorobenzyl, 9-anthrylmethyl, 2-cyanobenzyl, 2-methoxybenzyl, 2-nitrobenzyl, 1-naphthylmethyl, dimethoxybenzyl, 2-phenylbenzyl, α-(methyl)benzyl, α-(alkoxycarbonyl)benzyl, 2-pyridylmethyl, 2-hydroxyethyl, 2-aminoethyl, sodium 2-(sulfonate)ethyl, phenyl, pentafluorophenyl, 2-cyanophenyl, 2-(trifluoromethyl)-phenyl, 1-phenyl-1H-tetrazol-5-yl, isopropylcarbonyl, C₃₋₉ cycloalkanoyl, pivaloyl, triisopropylacetyl, α-alkoxy-, α-aryloxy- or α-N-tosyl-aminoacetyl optionally α-substituted with an alkyl or aryl, N-(trifluoroacetyl)prolyl, α-methoxy-α-(trifluoromethyl)phenylacetyl, O-acetyllactyl, α-acetoxyisobutyryl, α-(acetyl)acetyl, α-(alkoxycarbonyl)acetyl, camphanoyl, benzoyl, 2,4,6-trimethylbenzoyl, 2,4,6-triisopropylbenzoyl, 1-naphthoyl, 2-naphthoyl, 2-bromobenzoyl, 2-iodobenzoyl, 2-cyanobenzoyl, 2-trifluoromethylbenzoyl, 2-nitrobenzoyl, O-acetylsalicyloyl, dimethoxybenzoyl, 2-phenoxybenzoyl, 2-furoyl, 2-thiophenecarbonyl, 2-pyridinecarbonyl, quinaldyl, trimellitoyl, (alkoxycarbonyl)methyl, (tert-butoxycarbonyl)-methyl, α-(alkoxycarbonyl)ethyl, α-(alkoxycarbonyl)-α-methylethyl, C₄₋₁₀ aroylmethyl, tert-butoxycarbonyl (Boc), 9-fluorenylmethoxycarbonyl (Fmoc), (iso) menthoxycarbonyl, (di)alkyl-carbamoyl, N,N-alkylenecarbamoyl, N-pyrrolidinecarbonyl, carbazol-9-carbonyl, (N,N-dialkylcarbamoyl)methyl, (N,N-alkylenecarbamoyl)methyl, mesyl, tresyl, C₁₋₉ perfluoroalkanesulfonyl, benzenesulfonyl, pentafluorobenzenesulfonyl, p-toluenesulfonyl, 2-mesitylenesulfonyl, pentamethylbenzenesulfonyl, 2,4,6-triisopropylbenzenesulfonyl, 1-naphthalenesulfonyl, 2-naphthalenesulfonyl, 2-(methylsulfonyl)benzenesulfonyl, 8-quinolinesulfonyl, 2-thiophenesulfonyl, 4-methoxy-2,3,6-trimethylbenzenesulfonyl, α-toluenesulfonyl, o-anisolesulfonyl, 10-camphosulfonyl, (di)alkylsulfamoyl, N,N-alkylenesulfamoyl, triethylsilyl, triisopropylsilyl, triphenylsilyl, tert-butyl(dimethyl)silyl, dimethyl(isopropyl)silyl, cyclohexyl(dimethyl)silyl, dimethyl(phenyl)silyl, diisopropyl(methyl)silyl, 1,3,2-benzodioxaphosphole, 1,3,2-benzodioxaphosphole-2-oxide, 2,2′-ethylidene-bis(4,6-di-tert-butylphenoxy)phosphino, (1,1′-binaphthyl-2,2′-dioxy)phosphino, (1,1′-binaphthyl-2,2′-dioxy)phosphino-oxide, (1,1′-binaphthyl-3,3′-dimethylsilyl)-2,2′-dioxy)phosphino, di(menthoxy)phosphino, diisopropoxyphosphino, 4,5-diphenyl-1,3,2-dioxaphospholidine, diisopropylphosphino-oxide, diphenoxyphosphino, diphenylphosphino-oxide; OR⁰⁵ may also form a cycle with Ar for example a 2,3-dihydro-2,2-dimethyl-7-benzofuranyl or a group of formula (Ia):

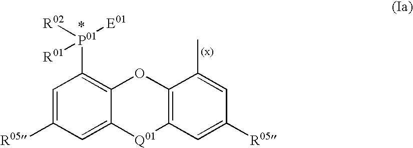

wherein:
p⁰¹* symbolizes an asymmetric phosphorus atom with P* and P⁰¹* atoms having identical absolute configurations,
(x) indicates the bond established between the group (Ia) and P*,
E⁰¹ represents independently from E what was previously defined for E,
Q⁰¹ symbolizes a C(Me)₂ or Si(Me)₂ group,
R⁰⁵″ represents a hydrogen atom, a C₁₋₁₀ group as methyl or tert-butyl,
R⁰¹ and R⁰² have the same signification as in the formula (I) and are defined here below,
   in SR⁰⁵, R⁰⁵ is as defined previously and in particular a hydrogen, an isopropyl, tert-butyl or C₆₋₁₀ aryl optionally substituted with one or several C₁₋₁₀ alkyl groups, C₅₋₁₀ aryl, or with heteroatoms such as O, N, Si, halogen,
   in SO₂R⁰⁵, R⁰⁵ represents an isopropyl, tert-butyl or C₅₋₆ cycloalkyl, a dialkylamino,
in N(R⁰⁶R⁰⁷), R⁰⁶ and R⁰⁷ represent independently from one another what was defined previously for R⁰⁵ and in particular a hydrogen, a C₁₋₁₀ straight or branched chain, a C₅₋₈ cycloalkyl, or also R⁰⁶ and/or R⁰⁷ may be linked with Ar (n=0) to form a cycle (for example a 2-methylindol-7-yl, carbazol-1-yl), or linked with each other (n=0 or 1) to form a C₄₋₇ cycle; or also R⁰⁶ or R⁰⁷ represent a C₁₋₃₆ acyl, C₄₋₁₄ aroyl, C₁₋₁₀ alkoxycarbonyl, a sulfonyl optionally substituted; all these groups possess or not one or several asymmetric carbon atoms symbolized by C*; or also N(R⁰⁶R⁰⁷) may form a salt with a mineral or organic acid, a quaternary ammonium with activated C₁₋₁₀ alkyls, or form a borane complex,
   in C(O)N(R⁰⁶R⁰⁷), R⁰⁶ and R⁰⁷ represent independently from one another what was defined previously for R⁰⁵ and in particular a hydrogen, a C₁₋₁₀ straight or branched chain, a C₅₋₈ cycloalkyl; or R⁰⁶ and R⁰⁷ may be linked to each other to form a C₄₋₇ cycle optionally substituted; or also C(O)N(R⁰⁶R⁰⁷) represent an oxazoline substituted in position 4 by one or two C₁₋₆ alkyl or aryl groups,
   R⁰¹ represents a hydrogen, a halogen as Cl, Br, I or F, particularly a Cl, a C₁₋₁₈ alkyl, C₅₋₇ cycloalkyl, C₄₋₁₄ aryl or heteroaryl, optionally substituted with one or several alkyl, alkoxy or aryl groups and/or with heteroatoms such as O, N, Si, P, halogen; or also R⁰¹ represents a C₅₋₁₄ aryloxy group, C₁-₁₈ alkoxy—possessing or not one or several asymmetric carbon atoms symbolized by C* or substituted with one or several halogens—, an amino group being a part of a C₄₋₆ aliphatic cycle, or a C₁₋₁₈ (di)alkylamino—wherein the alkyls, different or identical, possess or not one or several asymmetric carbon atoms symbolized by C* and optionally substituted with heteroatoms-; R⁰¹ represents also a Z′—(CR⁰³′R⁰⁴′)ₙ—Ar′ group as defined here below and different from Z—(CR⁰³R⁰⁴)ₙ—Ar; for example, R⁰¹ may be a methoxy, 2,2,2,-trifluoroethoxy, N- or O-ephedrino, N- or O-prolinolo, methyl, ethyl, propyl, isopropyl, butyl, sec-butyl, tert-butyl, cyclohexyl, phenyl, 1-naphthyl, 2-naphthyl, 2,3-dimethylphenyl, 3,5-dimethylphenyl, 5,6,7,8-tetrahydro-1-naphthyl, m- or p-anisyl, (trifluoromethyl)phenyl, 3,5-bis(trifluoromethyl)phenyl, pentafluorophenyl, trimethylsilylmethyl,
R⁰² is different from R⁰¹ and represents a C₁₋₁₈ alkyl, C₅₋₇ cycloalkyl, C₄₋₁₄ aryl or heteroaryl, optionally substituted by one or several alkyl, alkoxy, aryl groups and/or heteroatoms such as O, N, Si, P, halogen; R⁰² represents also a vinyl; in the particular case where R⁰² may represent an alkoxy group, R⁰¹ and R⁰² are linked to each other and form a C₂₋₃ aminoalkoxy hydrocarbon chain containing one or several asymmetric carbon atoms C*; or also R⁰² represents a skeleton of general formula (I′) linked to P* atom of (I) by (w) bond,

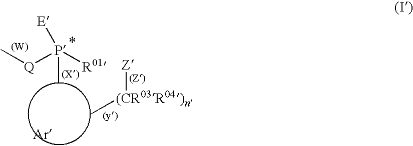

wherein:
n′ is a number equal to zero or 1,
P′* symbolizes an asymmetric phosphorus atom; with m≧1, P* and P′* atoms possess preferentially identical absolute configurations, —E′ represents independently from E what was defined previously for E, and E′ represents as well an oxygen atom,
R⁰³′ and R⁰⁴′ represent independently from one another and from R⁰³ and R⁰⁴ what was defined previously for R⁰³ and R⁰⁴, and particularly (CR⁰³′R⁰⁴′)_{n′} and (CR⁰³R⁰⁴)ₙ are identical,
Ar′ symbolizes a C₄₋₁₄ aromatic or polyaromatic group linked to P′* atom by (x′) bond and to Z′—(CR⁰³′R⁰⁴′)_{n′} group by (y′) bond in such a way that Z′—(CR⁰³′C⁰⁴′)_{n′} group is in 2- or ortho-position of P′* atom, and Ar′ represents independently from Ar what was defined previously 30 for Ar, and particularly Ar and Ar are identical,
(z′) indicates the bond established between (CR⁰³′R⁰⁴′)ₙ′ group and Z′, and when n′=0, then (y′) indicates the bond established between Ar′ and Z′,
Z′ represents independently from Z what was defined previously for Z,
R⁰¹′ represents independently from R⁰¹ what was defined previously for R⁰¹, and particularly R⁰¹′ and R⁰¹ are identical,
Q represents a hydrocarbon chain, interrupted optionally by heteroatoms, as —C(R⁰⁸R⁰⁹)—, (—CH(R⁰⁸))₂ (in this case, the R⁰⁸ groups may be linked to form a cycle optionally substituted), (—CH(R⁰⁸))₂CH₂, (—CH₂)₂Si(R⁰⁸R⁰⁹), (—CH₂)₂P(E″)(R⁰⁸), —CH(R⁰⁸)CH₂CH₂CH(R⁰⁸)—, (—CH(R⁰⁸)CH₂)₂O, (—CH(R⁰⁸)CH₂O)₂P(E″)(R⁰⁸), or also 1,2-phenylene, ferrocene-1,1′-diyl, 2,6-bis(dimethylene)pyridine, N—(R⁰⁵)-pyrrolidine-3,4-diyl; wherein N—(R⁰⁵)—, R⁰⁸ and R⁰⁹ represent as described previously, and E″ represents independently from E and E″ what was defined previously for E and also an O atom; particularly Q represents a CH₂, (CH₂)₂, (CH₂)₃, (CH₂)₄, (—CH₂)₂—SiMe₂, (—CH₂)₂SiBn₂, (—CH₂)₂SiPh₂, 1,2-phenylene, fenocene-1,1′-diyl,
   excluding compounds of formula (I) where m=1 with the following significations:
   with E representing 2e⁻ or BH₃: Z—(CR⁰³R⁰⁴)ₙ—Ar represents an o-anisyl; R⁰¹ represents a phenyl or methyl,
R⁰² represents a methyl, cyclohexyl, cyclopentadienyl, phenyl, 1-naphthyl, 2-naphthyl, halogen, 1-(2-hydroxy)ethyl, 1-(2-amino-2-phenyl)ethyl, alkoxy, aryloxy, (di)alkylamino, a (alkanesulfonyl)methyl group or (N,N-dialkylaminosulfonyl)methyl,
   with E representing 2e⁻ or BH₃: R⁰¹ represents a phenyl; R⁰² represents an o-anisyl, Z—(CR⁰³R⁰⁴)ₙ—Ar represents 2-(hydroxy)-1-naphthyl, 2-(O-acetyllactoxy)-1-naphthyl, 2-(O-diphenylphosphino-E⁰²)oxy-1-naphthyl where E⁰² represents 2e⁻ or BH₃,
   with E representing 2e⁻: R⁰¹ represents phenyl; R⁰² represents methyl, Z—(CR⁰³R⁰⁴)ₙ—Ar represents 2-methoxy-1-naphthyl, 2-acetoxy-1-naphthyl,
   with E representing 2e⁻ or HBr: R⁰¹ represents phenyl; R⁰² represents methyl, Z—(CR⁰³R⁰⁴)ₙ—Ar represents 2-hydroxyphenyl, 2-(3,3′,5,5′-tetra-tert-butyl-1,1′-bisphenyl-2,2′-phosphite)phenyl, 2-(3,3′-di-tert-butyl-5,5′,6,6′-tetramethyl-1,1′-bisphenyl-2,2′-phosphite)phenyl, 2,7-di-tert-butyl-9,9-dimethyl-5-(methylphenylphosphino-E⁰²)xanth-4-yl where E⁰² represents 2e⁻, BH₃ or O,
   with E representing 2e⁻: Z−(CR⁰³R⁰⁴)ₙ—Ar is 2-cam-5-methylphen-1-yl, R⁰¹ represents phenyl; R⁰² represents isopropyl,
   with E representing 2e⁻:
Z—(CR⁰³R⁰⁴)ₙ—Ar represents an oxazoline substituted on position 4 by methyl, isopropyl, tert-butyl, phenyl,
R⁰¹ represents a phenyl; R⁰² represents 1-naphthyl, 2-naphthyl, 2-biphenylyl,
   with E and E′ identical representing 2e⁻ or BH₃: Q represents CH₂CH₂ Z—(CR⁰³R⁰⁴)ₙ—Ar and Z′—(CR⁰³′R⁰⁴′)^{n′}—Ar′ identical represent an o-anisyl, R⁰¹ and R⁰¹′ identical and represent ethyl, cyclohexyl, phenyl, 2-naphthyl, anisyl, chlorophenyl, (methanesulfonyl)phenyl, p-(N,N-dimethylamino)phenyl, thioanisyl,
   with E and E′ identical representing 2e⁻: Q represents CH₂CH₂,
R⁰¹ and R⁰¹′ identical and represent phenyl,
Z—(CR⁰³R⁰⁴)ₙ—Ar and Z′—(CR⁰³′R⁰⁴′)_{n′}—Ar′ identical represent o-hydroxyphenyl, o thio anisyl, o-(methanesulfonyl)phenyl, o-acetyl-phenyl, 2-methoxy-4-(sodium sulfonyl)-phenyl, 2-methoxy-4-(N,N-dimethylaminosulfonyl)phenyl,
   with E and E′ identical representing 2e⁻ or BH₃:
Z—(CR⁰³R⁰⁴)ₙ—Ar and Z′—(CR⁰³′R⁰⁴′)_{n′}—Ar′ identical represent an o-anisyl,
R⁰¹ and R⁰¹′ identical and represent phenyl,
Q represents CH₂SiMe₂CH₂, CH₂SiPh₂CH₂, CH₂SiBn₂CH₂, 1,1′-ferrocenyl, 2,6-bis(dimethylene)pyridine, N—(R⁰⁵)-pyrrolidine-3,4-diyl.

The invention is embodied by the preparation of P-chiral ortho-hydroxy-, amino-, carboxy-arylphosphines, their precursors and derivatives of general formula (I), starting from an optically active oxazaphosphacycloalkane-borane of formula (Ib) derived from an optically active aminoalcool HN(R⁰⁶)-Q⁰²*—0H,

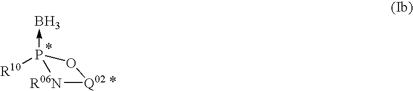

wherein:
R¹⁰ represents a methyl, (trimethylsilyl)methyl, isopropyl, tert-butyl, adamantyl, C₅₋₇ cycloalkyl, C₄₋₁₄ aryl optionally substituted, an ortho-Z(CR⁰³R⁰⁴)ₙ—Ar as defined previously and in particular an ortho-(R⁰⁵O(CH₂)ₙ)—Ar where n equals 0 or 1, R⁰⁵ represents a hydrogen atom, isopropyl, tert-butyl or cyclohexyl, and Ar represents a phenyl or naphthyl optionally substituted with one or several C₁₋₁₀ alkyls and/or alkoxys, also optionally substituted or may form a cycle between each other,
Q⁰²* symbolizes a C₂₋₃ alkyl chain containing one or several asymmetric carbon atoms, and which may be also linked to N by R⁰⁶, R⁰⁶ being as defined previously; for example, R⁰⁶N-Q⁰²*-O may derive from optically pure ephedrine or prolinol.

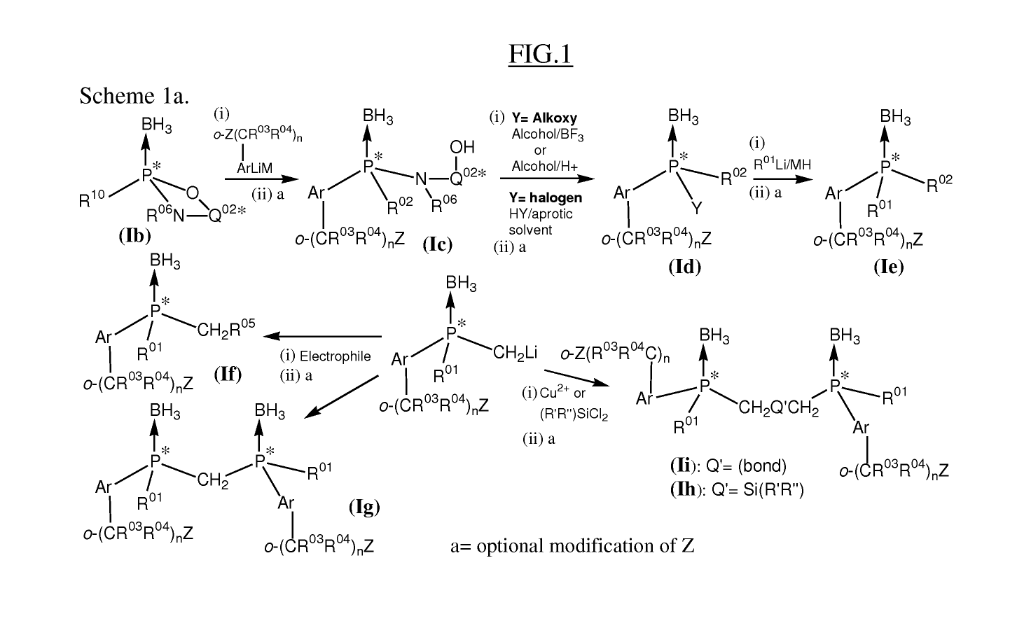

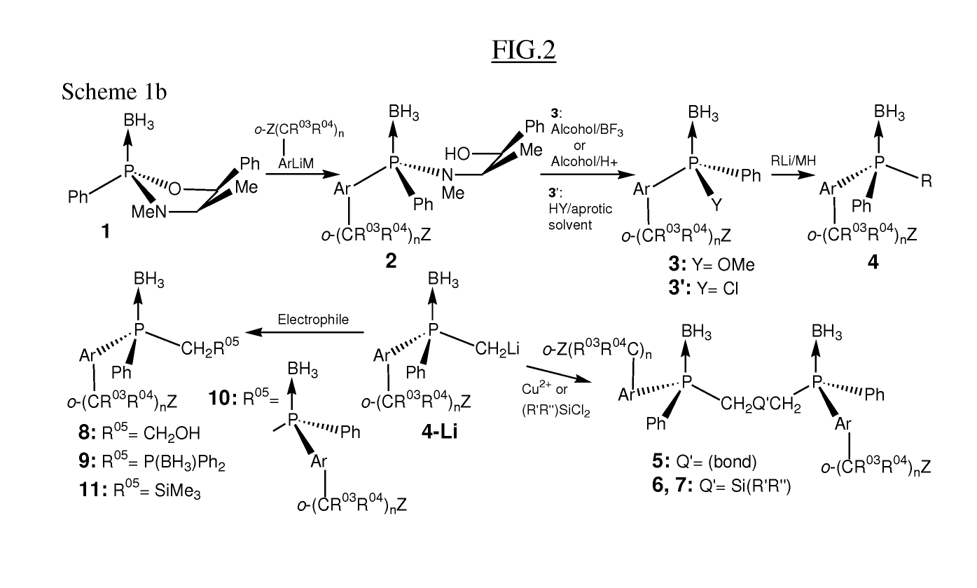

The synthetic strategy—FIG. 1, scheme 1a-, exemplified by using optically pure ephedrine and R¹⁰=phenyl—FIG. 2, scheme 1b-, allows the introduction of the different desired functionalities in the proximity of the phosphorus atom. It is understood that where one enantiomer is represented, the other enantiomer is similarly prepared. Next, metal complexes of the new phosphines were prepared and used in asymmetric catalysis.

The adopted experimental procedures to prepare compounds of general formula (I) according to the claimed process are in general dictated by the chemical nature of starting material. Performing such reactions is for those skilled in the art. Optically pure oxazaphos-phacycloalkane-borane of formula (Ib) may be prepared as described by Jugé et al or Brown.

Thus, for example the cycle of oxazaphospholidine-borane complex 1 derived from optically pure ephedrine, was opened with various functionalized organo(di)metallics prepared from ortho-Z(CR⁰³R⁰⁴)ₙ—-ArBr or Z(CR⁰³R⁰⁴)ₙ—ArH (n=0 or 1) either by transmetallation with for example butyllithium (1-2 equivalents) or by reaction with a base such as MH (M=Li, Na, K) (˜1 equivalent) followed by butyllithium (1 equivalent), to yield the corresponding ortho-Z(CR⁰³R⁰⁴)ₙ—Ar-aminophosphine-borane 2 in high yield. ¹H NMR showed the formation of a single diastereomer, and the X-ray diffraction analysis provided the structures of the aminophosphine-boranes 2a and 2b, derived from o-bromophenol and 2-bromo-1-naphthol, respectively. These aminophosphine-boranes (Ic) constitute the precursors of various phosphinite-boranes and halogenophosphine-boranes (Id).

Acid alcoholysis with for example methanol/sulfuric acid, or the P—N bond cleavage of 2 by an alcohol, e.g. methanol, assisted by BF₃ afforded the correponding methyl phosphinite-borane 3 in high yield and >99% ee according to HPLC analysis. The X-ray diffraction analysis of the o-(methyl phenylphosphinito-borane)phenol (S)-Mosher acid ester 3an provided the absolute configuration of the phosphorus atom. ¹H and ¹⁹F NMR showed the formation of single diastereomer. In addition, BF₃ assisted P—N bond cleavage of 1 in methanol afforded a diastereomerically pure phosphonite-borane as shown by ¹H, ¹³C and ³¹P NMR. The P—N bond rupture of 2 in an aprotic solvent by an acid halide as HCl, leads to the corresponding chlorophosphine-borane 3′ in high yield. These phosphinite-boranes and chlorophosphine-boranes (Id) constitute the precursors of various phosphine-boranes (Ie).

The displacement of the methoxy group in 3 was carried out by the action of either an alkyl- or aryllithium (1-2 equivalents), or by the prior treatment with a base such as MH (M=Li, Na, K) (˜1 equivalent) followed by the alkyl- or aryllithium (1 equivalent). The corresponding phosphine-borane 4 was obtained in high yield. The enantiomeric purity >99% was confirmed by ¹H and ¹⁹F NMR of o-(methylphenylphosphino-borane)phenol (S)-Mosher acid ester 4an and by transforming 4a into PAMP.BH₃ (4aa) and HPLC analysis. Also, chlorophosphine-borane 3′ reacts with organometallics leading to the corresponding phosphine-borane 4 or reacts with a hydroxyarene leading to the corresponding aryl phosphinite-borane. These phosphine-boranes (Ie) may be also prepared by action of functionalized organometallics with phosphinite-boranes or chlorophosphine-boranes prepared following Jugé et al route.

As example of α-functionalization of the phosphorus atom (preparation of (If), (Ig), (Ih) and (Ii)), the methyl of methylphosphine-borane 4 was deprotonated with a strong base as sec-butyllithium (addition of 1-2 equivalents of the organolithium) or by the prior treatment with a base such as MH (M=Li, Na, K) (˜1 equivalent) followed by sec-butyllithium (1 equivalent). This anion 4-Li was dimerized to 5 by anhydrous Cu(II) salt or condensed on a (R′R″)SiCl₂ (e.g. Me₂SiCl₂, Ph₂SiCl₂) leading to (—CH₂Si(R′R″)CH₂—)-bridged diphosphine-borane 6, 7 in good yields. Also, this anion 4-Li was reacted with electrophiles (according to Imamoto et al, J. Am. Chem. Soc. 1990, 112, 5244-5252; Jugé et al, Tetrahedron: Asymm 2004, 15, 2061-2065) yielding a phosphine-borane possessing a R⁰⁵ arm, e.g. R⁰⁵═CH₂OH 8, or a (—CH₂—)-bridged diphosphine-borane, e.g. R⁰⁵═P(BH₃)Ph₂ 9.

In particular, the (o-hydroxyaryl)phenylphosphine-borane 4, its precursors and derivatives are crystallin and are obtained in high chemical and optical purities.

Under the action of a base (carbonate, hydride, organometallic—the metal selected among Li, Na, K, Cs—, amine optionally on solid support), the Z function of phosphines, their precursors and derivatives, could be modified—as well as the functionalized R⁰⁵ arm on α of P* as CH₂OH—with various groups possessing different properties such as alkyls, activated aryls, fluoroalkyls, fluorobenzyls, silyls, acyls, aroyls, acetates, phosphates, phosphites, triflate, sulfonates, alkylammoniums, rendering them as well as their metal complexes, more soluble in the reaction medium (water, alcohols, ionic liquids, perfluorinated solvents, etc) or recyclable by solid-liquid or liquid-liquid phase separation (scheme 2: example with (o-hydroxyaryl)phenylphosphino-borane).

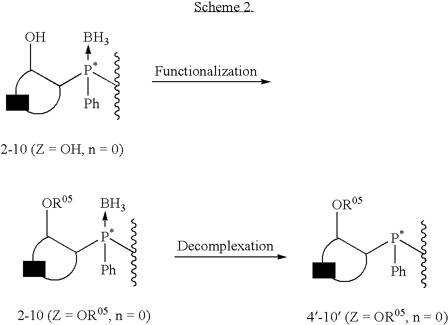

For example, the aromatic hydroxy group of (o-hydroxyaryl)-N-ephedrinophosphine-borane 2 (Z═OH, n=0), methyl (o-hydroxyaryl)phosphinite-borane 3 (Z═OH, n=0), (o-hydroxyaryl)phenylphosphine-borane 4 (Z═OH, n=0) and bis((o-hydroxyaryl)phenyl-phosphino-borane)alkane 5-7 (Z═OH, n=0), was easily functionalized under standard conditions in high yield. In the same manner, bis or poly(o-O-aryl)phenylphosphine-boranes (Z═OR⁰⁵, n=0; R⁰⁵=bis or poly-linker) were prepared in high yields by condensation of (o-hydroxyaryl)phenylphosphine-borane 4 (Z═OH, n=0) on a bifunctional alkane or heteroalkane (e.g. ethylene glycol ditosylate, diethylene glycol ditosylate), or a polyfunctional arylalkane (e.g. 2,4,6-tris(bromomethyl)mesitylene).

The (o-R⁰⁵O-aryl)phosphine-boranes 4 (Z═OR⁰⁵, n=0) and bis((o-R⁰⁵O-aryl)-phosphino-borane)alkanes 5-7 (Z═OR⁰⁵, n=0) were decomplexed at 0 to 75° C.—for example with an amine or an acid as HBF₄ followed by a basic treatment (Imamoto et al, ibid; Livinghouse et al, Tetrahedron Lett. 1994, 35, 9319)—affording the corresponding phosphines 4′-7′ with high yields. This decomplexation could be applied to the other phosphine-boranes.

The inventors have found other access routes to 5a starting from DiPAMP (5′aa) or its BH₃ adduct 5aa by demethylation of the o-anisyl group with BBr₃ followed by complexation with BH₃ (scheme 3). This route is also applicable to the synthesis of o-(methylphenyl-phosphino-borane)phenol 4a via o-(methylphenylphosphino)phenol 4′a. Demethylation of the o-anisyl group could be achieved under other conditions as described by Greene and Wuts (Protective groups in organic synthesis, John Wiley & Sons 1999).

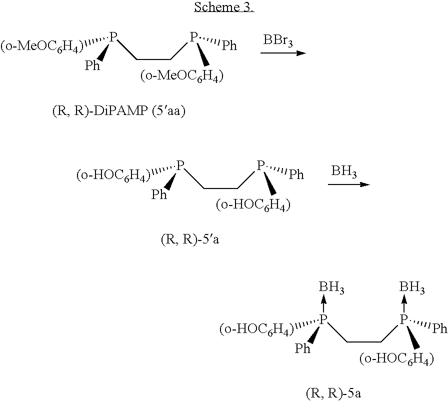

The ortho-functionalized P-chiral arylphosphines could be modified on the phosphorus is atom by other groups than BH₃ as O or acid such as HBF₄, TfOH, HClO₄, HPF₆, HBr, HI.

The new chiral structures part of the invention 5′a, 5′ab, 5′ac, 5′b, 6′a, Ta and 10′a can be denoted by the acronyms mentioned hereinafter:

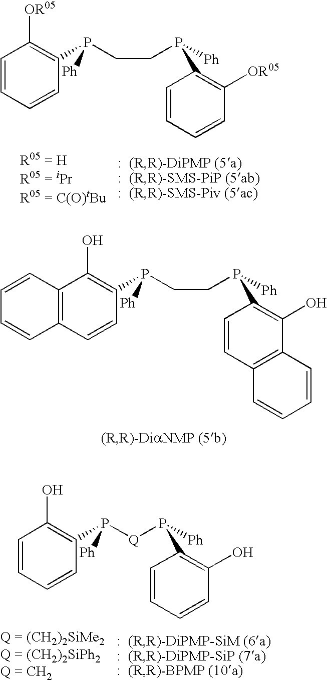

The present invention aims as well the use of optically active compounds of general formula (I) for the preparation of coordination metal complexes useful as catalysts to perform asymmetric syntheses in organic chemistry. These metal complexes prepared in an appropriate solvent are based on a transition metal and as ligand of the metal, at least an optically active form of a compound of general formula (I) wherein E and/or E′ represent 2e⁻; and as example of neutral, cationic or anionic metal complexes, one can mention especially those of the general formula (III),

MₚL_{q}(X′)ᵣ(Sᵥ)ₛ(Sᵥ′)_{s′}Hₜ (III)

wherein:
M represents a transition metal chosen among rhodium, ruthenium, iridium, cobalt, palladium, platinum, nickel or copper,
L represents an optically active compound of general formula (I) as defined previously wherein E and/or E′ represent 2e⁻, and E and/or E⁰¹ represent 2e⁻,
when the complex is cationic, X′ represents an anionic coordinating ligand such as halide ions Cl, Br or I, an anionic group such as OTf, BF₄, ClO₄, PF₆, SbF₆, BPh₄, B(C₆F₅)₄, B(3,5-di-CF₃—C₆H₃)₄, p-TsO, OAc, or CF₃CO₂ or also π-allyl, 2-methylallyl, and when the complex is anionic, X′ represents a cation such as Li, Na, K, unsubstituted or alkyl substituted ammonium,
Sᵥ and Sᵥ′ represent independently from one another, a ligand molecule such as H₂O, MeOH, EtOH, amine, 1,2-diamine (chiral or not), pyridine, a ketone as acetone, an ether as THF, a sulfoxide as DMSO, an amide as DMF or N-methylpyrrolidinone, an olefin as ethylene, 1,3-butadiene, cyclohexadiene, 1,5-cyclooctadiene, 2,5-norbornadiene, 1,3,5-cyclooctatriene, or an unsaturated substrate, a nitrile as acetonitrile, benzonitrile, an arene or C₅₋₁₂ eta-aryl optionally substituted by one or several C₁₋₅ alkyls, iso- or tert-alkyls, as benzene, p-cymene, hexamethylbenzene, pentamethylcyclopentadienyl,
H represents a hydrogen atom,
p is a number equal to 1 or 2; q is an integer varying from 1 to 4; r is an integer varying from 0 to 4; s and s′ independently from one another are integers varying from 0 to 2; t is an integer varying from 0 to 2.

The catalyst may be prepared from optically active P-chiral compounds of general formula (I) in association with a compound provider of the metal (catalyst precursor) in an appropriate solvent according to literature protocoles (Osborn et al, J. Am. Chem. Soc. 1971, 93, 2397; Genêt, Acros Organics Acta 1994, 1(1), 1-8). According to the invention, the catalyst may consist of a preformed metal complex as defined previously, may be generated in situ in the reaction medium optionally in the presence of a substrate, or activated prior to use. The optimum proportion of optically active ligand to the metal may vary according to the ligand and the metal and may be easily determined experimentally; for example, the quantity of optically active ligand to be added may vary from 1 to 4 equivalents to the metal. It is understood that when one enantiomer is used, the other enantiomer is similarly applicable.

The present invention describes also a process to prepare rhodium catalysts from optically active P-chiral compounds of general formula (I) and a precursor as [(diene)₂Rh]X where the diene may be 2,5-norbomadiene, 1,5-cyclooctadiene and X may be BF₄, OTf and it also describes a process to prepare ruthenium catalysts by addition of optically active P-chiral compounds of general formula (I) to a precursor as [(diene)RuX₂]ₓ or [(diene)(1,3,5-cyclooctatriene)RuH]X where the diene may be 1,5-cyclooctadiene, 2,5-norbornadiene and X may be Cl, Br, I, BF₄, OTf, PF₆ and x is a number equal to 1 or 2. The last precursors were prepared from [(diene)ruthenium(2-methylallyl)] and the corresponding acid in presence or not of a diene.

Another aim of the present invention is the use of the mentioned complexes to perform asymmetric syntheses in organic chemistry. In fact, asymmetric transformation such as hydrogenation, transfer hydrogenation, hydrosilylation, hydroboration, hydroformylation, isomerization of olefins, hydrocyanation, hydrocarboxylation, electrophilic allylation, implicating prochiral molecules which possess one or several C═C, C═O and/or C═N bonds, may be carried out with catalysts containing at least an optically active form of a compound of general formula (I) (E and/or E′ represent 2e⁻), in association with a transition metal derivative as described previously. These asymmetric transformations may be performed under known conditions, or which could be determined, by the man of the art according to described procedures with other phosphines (Pfaltz et al, Comprehensive Asymmetric Catalysis, Springer Verlag 1999, vol. I-III; Noyori, Asymmetric Catalysis in Organic Synthesis, John Wiley & Sons 1994). The asymmetric reduction takes place in general in an organic solvent at a temperature ranging between −10° C. and 100° C., in the presence of either H₂ gas under 1 to 150 bars, a hydrogen donor, a reducing agent such as a borane, a silane, or in the presence of a selected combination among all what preceded. The catalyst may be used at 0.00001 to 5% to the substrate and this amount could be easily determined experimentally. The appropriate prochiral substrates to the asymmetric reduction using metal complexes according to the invention, and which contain C═C, C═O, and/or C═N bonds, include, but are not limited to prochiral olefins as glycine alkylidene derivatives optionally substituted, α- and/or β-substituted maleic acid derivatives, succinic acid alkylidene derivatives, α- and/or β-substituted cinnamic or acrylic acid derivatives, derivatives of ethylene, enamides, enamines, enols, enol ethers, enol esters, allylic alcohols, prochiral ketones optionally substituted and/or α-unsaturated, α- or β-ketoacid derivatives, diketones and derivatives, prochiral imine derivatives, oximes, also their salts, mono/di -esters or -amides, and substituted derivatives of the mentioned substrates.

This transformation may be conducted also with racemic substrates possessing C═C, C═O, or C═N bonds according to the principle of dynamic kinetic resolution. The result of these transformations is the preparation of enantiomerically enriched products following the modification or saturation of C═C, C═O, or C═N bonds, for example preparation of optically active derivatives of α- or β-amino acids, acids or diacids, amines, alcohols, alkanes. The asymmetric reduction was carried out, illustratively and not limitedly, on model substrates.

The present invention is described in more detail by the following EXAMPLES, which are not to be construed as limitative.

### Synthesis of P-Chiral Phosphorus Compounds

All operations were conducted under N₂ or Ar atmosphere using anhydrous and degassed solvents. The synthesis of various noncommercially available chemicals as o-bromophenols, o-bromoanilines, o-bromobenzylamines, o-bromobenzamides, etc, was according to known procedures. L* stands for the P-chiral ligand. ¹H (300 MHz, internal Me₄Si), ¹³C (75 MHz, internal CDCl₃), ¹⁹F (282 MHz, internal CFCl₃), and ³¹P NMR (120 MHz, external 85% H₃PO₄) were recorded for solutions in CDCl₃ if not stated otherwise (J in Hz).

### General procedure 1: Synthesis of aminophosphine-boranes 2

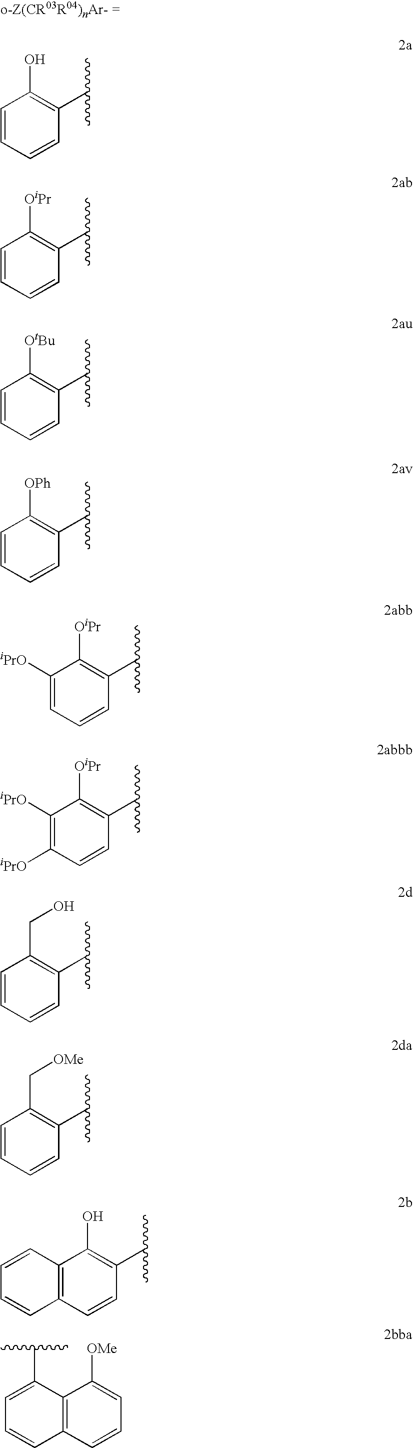

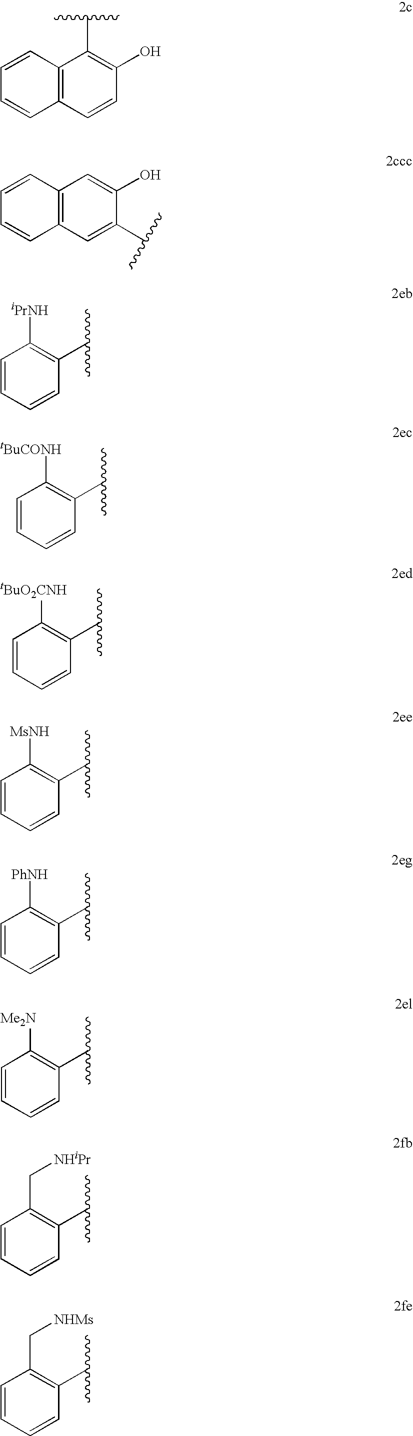

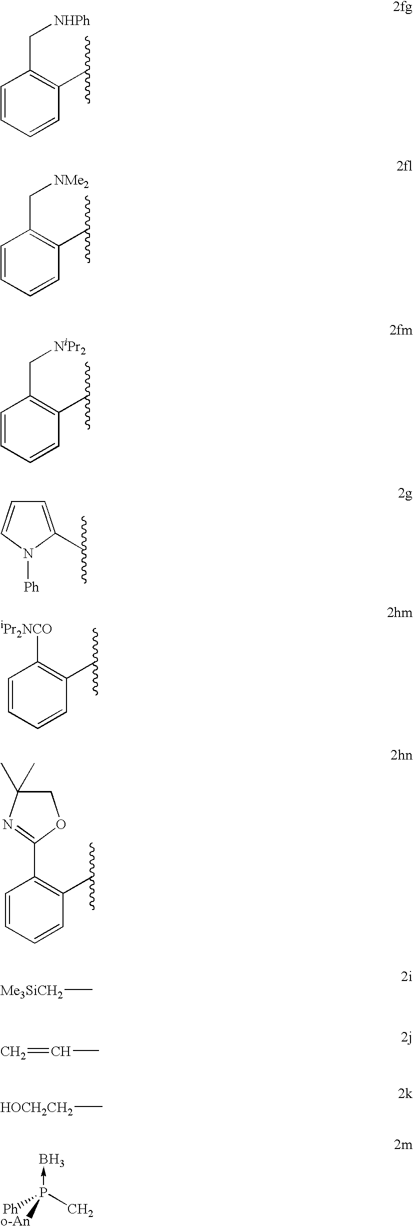

To a cold (0° C.) solution of bromoarene (or arene having an ortho directing group) (1.2-1.3 equiv.) in ether, cyclohexane or THF is added under stirring (A) an oil-free NaH (1.3-1.5 equiv.) followed by n- or sec-BuLi (1.2-1.3 equiv.) or (B) n-, sec- or tert-BuLi (1.2-1.3 equiv. in case a monoanion is to be generated; 2.4-2.6 equiv. for a dianion). The mixture is left at room temperature (or refluxed) until the transmetallation is complete. To this mixture at −30° C., a THF (or ether) solution of oxazaphospholidine-borane 1 is slowly added and the resulting mixture left to warm up to room temperature. The reaction is hydrolyzed with water after disappearance of the starting 1 as monitored by thin layer chromatography (TLC). The mixture is concentrated, and water (or acidified water until neutral pH is reached) added and the residue is extracted with CH₂Cl₂. Drying over Na₂SO₄, concentration and purification of the residue on silica gel and/or by crystallization affords compound 2 in 75-90% yield.

### EXAMPLE 1

2a according to 1(A) or (B). ¹H NMR δ 0.35-1.80 (m, 3H), 1.25 (d, 3H), 1.94 (b s, 1H), 2.56 (d, 3H), 4.11 (dq, 1H), 4.80 (d, 1H), 6.84 (m, 1H), 6.99 (m, 2H), 7.26-7.49 (m, 11H), 8.1 (br s, 1H); ³¹P NMR δ +66.11 (m).

### EXAMPLE 2

The enantiomer of 2a is prepared from the enantiomer of 1.

### EXAMPLE 3

2ab according to 1(B). ¹H NMR δ 0.30-1.80 (b m, 3H), 0.90 and 0.93 (2d, 6H), 1.22 (d, 3H), 1.81 (d, 1H), 2.61 (d, 3H), 4.33 (m, 1H), 4.42 (sept, 1H), 4.89 (dd, 1H), 6.81 (dd, 1H), 7.00 (m, 1H), 7.10-7.50 (m, 11H), 7.75 (m, 1H); ³¹P NMR δ +68.66 (m).

### EXAMPLE 4

2b according to 1(A) or (B). ¹H NMR δ 0.66-2.00 (br m, 3H), 1.27 (d, 3H), 1.82 (br s, 1H), 2.60 (d, 3H), 4.17 (m, 1H), 4.85 (d, 1H), 6.96 (t, 1H), 7.23-7.62 (m, 13H), 7.75 (dd, 1H), 8.39 (dd, 1H), 9.09 (br s, 1H); ³¹P NMR δ +65.44 (m).

### EXAMPLE 5

2bba according to 1(B). ¹H NMR δ 0.50-1.85 (m, 3H), 1.28 (d, 3H), 2.01 (br s, 1H), 2.36 (d, 3H), 3.01 (s, 3H), 4.58 (br s, 1H), 5.00 (d, 1H), 6.54 (m, 1H), 7.10-7.57 (m, 13H), 7.77-7.91 (m, 2H); ³¹P NMR δ +77.90 (br s).

### EXAMPLE 6

2c according to 1(A) or (B). ¹H NMR δ 1.29 (d, 3H), 0.90-1.93 (br m, 3H), 2.65 (d, 3H), 4.13 (m, 1H), 4.85 (d, 1H), 7.27-7.55 (m, 12H), 7.59-7.73 (m, 4H), 7.92 (br s, 1H); ³¹P NMR δ +65.49 (m).

### EXAMPLE 7

2d according to 1(A) or (B). ¹H NMR δ 0.50-1.70 (br m, 3H), 1.23 (d, 3H), 2.62 (d, 3H), 4.25 (m, 1H), 4.55 and 4.64 (2d, 2H), 4.89 (d, 1H), 7.13-7.63 (m, 14H); ³¹P NMR δ +68.90 (m).

### EXAMPLE 8

2da according to 1(B). ¹H NMR δ 0.50-1.80 (br m, 3H), 1.25 (d, 3H), 2.64 (d, 3H), 3.19 (s, 3H), 4.30 (m, 1H), 4.33 and 4.54 (2d, 2H), 4.87 (d, 1H), 7.20-7.69 (m, 14H); ³¹P NMR δ +68.88 (m).

### EXAMPLE 9

2eb according to 1(B). ¹H NMR δ 0.58-2.00 (br m, 3H), 1.18 (‘t’, 6H), 1.26 (d, 3H), 2.64 (d, 3H), 3.67 (m, 1H), 4.22 (m, 1H), 4.86 (d, 1H), 5.38 (br d, 1H), 6.53 (m, 1H), 6.66 (m, 1H), 6.88 (m, 1H), 7.23-7.50 (m, 11H); ³¹P NMR δ +66.41 (m).

### EXAMPLE 10

2ec according to 1(B). ¹H NMR δ 0.60-1.70 (br m, 3H), 0.83 (s, 9H), 1.18 (d, 3H), 2.50 (d, 3H), 4.28 (m, 1H), 4.92 (m, 1H), 7.10, 7.30 and 7.53 (3m, 14H).

### EXAMPLE 11

2ed according to 1(B). ¹H NMR δ 0.70-1.73 (br m, 3H), 1.26 (d, 3H), 1.40 (s, 9H), 1.90 (d, 1H), 2.63 (d, 3H), 4.26 (m, 1H), 4.80 (t, 1H), 6.96-7.07 (m, 2H), 7.21-7.51 (m, 11H), 8.01 (dd, 1H), 8.06 (br s, 1H).

### EXAMPLE 12

2ee according to 1(A) or (B). ¹H NMR δ 0.62-1.67 (br m, 3H), 1.26 (d, 3H), 2.69 (d, 3H), 3.00 (s, 3H), 4.13 (m, 1H), 4.93 (d, 1H), 6.92 (br s, 1H), 7.06 (m, 1H), 7.16-7.45 (m, 11H), 7.60 (m, 2H).

### EXAMPLE 13

2el according to 1(B). ¹H NMR δ 0.77-1.98 (br m, 3H), 1.22 (d, 3H), 2.41 (s, 6H), 2.60 (d, 3H), 4.35 (m, 1H), 4.96 (d, 1H), 7.12-7.58 (m, 14H); ³¹P NMR δ +69.56 (m).

### EXAMPLE 14

2fb according to 1(B). ¹H NMR δ 0.40-1.55 (br m, 3H), 0.93 and 1.09 (2d, 6H), 1.28 (d, 3H), 1.83 (d, 1H), 2.74 (d, 3H), 3.69 (m, 1H), 4.25 (m, 2H), 4.48 (dd, 1H), 5.04 (m, 1H), 7.21-7.58 (m, 14H); ³¹P NMR δ +95.73 (m).

### EXAMPLE 15

2fe according to 1(B). ¹H NMR δ 0.20-1.32 (br m, 3H), 0.95 (d, 3H), 2.53 (d, 3H), 2.57 (s, 3H), 3.15 (m, 2H), 4.00 (m, 1H), 4.98 (m, 1H), 7.07 (m, 1H), 7.30 (m, 10H), 7.63 (m, 1H), 7.73 (m, 1H), 7.88 (m, 1H).

### EXAMPLE 16

2fl according to 1(B). ¹H NMR δ 0.81-1.80 (br m, 3H), 1.22 (d, 3H), 2.19 (s, 6H), 2.74 (d, 3H), 3.39 and 3.89 (2d, 2H), 4.21 (m, 1H), 4.74 (d, 1H), 7.28 (m, 6H), 7.45 (m, 5H), 7.59 (m, 2H), 7.76 (m, 1H); ³¹P NMR δ +70.41 (m).

### EXAMPLE 17

2fm according to 1(B). ¹H NMR δ 0.72-1.90 (br m, 3H), 0.86 and 0.88 (2d, 12H), 1.26 (d, 3H), 2.66 (d, 3H), 2.91 (sept, 2H), 3.57 (m, 2H), 4.36 (m, 1H), 4.93 (m, 1H), 7.18-7.33 (m, 6H), 7.35-7.49 (m, 5H), 7.62 (m, 2H), 8.06 (m, 1H); ³¹P NMR δ +66.93 (m).

### EXAMPLE 18

2g according to 1(B). ¹H NMR δ 0.33-1.38 (br m, 3H), 0.71 (d, 3H), 1.70 (d, 1H), 2.68 (d, 3H), 3.89 (m, 1H), 4.80 (m, 1H), 6.18, 6.24 and 7.02 (3m, 3H), 7.16-7.30 (m, 5H), 7.33-7.47 (m, 8H), 7.70 (m, 2H); ³¹P NMR δ +55.14 (m).

### EXAMPLE 19

2hm according to 1(B). ¹H NMR δ 0.50-1.83 (br m, 3H), 1.08, 1.22, 1.42, 1.52 and 1.72 (5d, 15H), 3.10 (d, 3H), 3.48 (m, 1H), 3.59 (sept, 2H), 3.84 (m, 1H), 3.93 (sept, 2H), 5.37 (br s, 1H), 6.87 (m, 2H), 7.05-7.21 (m, 3H), 7.30-7.62 (m, 9H); ³¹P NMR δ 69.67 (m).

### EXAMPLE 20

2hn according to 1(B). ¹H NMR δ 1.17 (d, 3H), 1.24 and 1.44 (2s, 6H), 0.40-1.70 (br s, 3H), 2.92 (d, 3H), 3.74 and 4.10 (2d, 2H), 3.84 (m, 1H), 4.42 (d, 1H), 7.01 (m, 2H), 7.19 (m, 3H), 7.40-7.58 (m, 8H), 7.74 (m, 1H); ³¹P NMR δ +71.37 (m).

### EXAMPLE 21

2i from 1 using 1.2 equiv. TMSCH₂Li, or MeLi (2.2 equiv.) followed by excess of TMSCl. ¹H NMR δ 0.07 (s, 9H), 0.35-1.50 (br m, 3H), 1.04 (d, 3H), 1.08 (dd, 1H), 1.39 (dd, 1H), 1.82 (d, 1H), 2.59 (d, 3H), 3.95 (m, 1H), 4.84 (t, 1H), 7.28-7.46 (m, 7H), 7.57 (m, 3H); ³¹P NMR δ +66.88 (m).

### EXAMPLE 22

2j from 1 using 2.2 equiv. TMSCH₂Li followed by excess of paraformaldehyde or starting from 2i using sec-BuLi (2.2 equiv.) followed by excess of paraformaldehyde. ¹H NMR δ 0.19-1.39 (br m, 3H), 1.28 (d, 3H), 1.89 (d, 1H), 2.47 (d, 3H), 4.14 (m, 1H), 4.78 (m, 1H), 6.09-6.46 (m, 3H), 7.04 (m, 2H), 7.25 (m, 2H), 7.36 (m, 4H), 7.47 (m, 2H); ³¹P NMR δ +66.91 (m).

### EXAMPLE 23

2k from 1 using MeLi (2.2 equiv.) followed by excess of paraformaldehyde. ¹H NMR δ 0.16-1.46 (br m, 3H), 1.14 (d, 3H), 2.09-2.37 (m, 3H), 2.53 (d, 3H), 3.70-4.00 (m, 3H), 4.76 (d, 1H), 7.25-7.42 (m, 10H); ³¹P NMR δ +66.76 (m).

### EXAMPLE 24

2m from (S)-PAMP.BH₃ anion and 1. ¹H NMR δ 0.05-1.60 (br m, 6H), 1.17 (d, 3H), 1.90 (br s, 1H), 2.89 (d, 3H), 2.96 (m, 1H), 3.64 (m, 1H), 3.79 (s, 3H), 3.98 (m, 1H), 5.07 (br s, 1H), 6.92 (m, 1H), 7.10 (m, 1H), 7.17-7.68 (m, 16H), 8.05 (ddd, 1H); ³¹P NMR δ +11.49 (br s), +66.92 (br s).

### General Procedure 2: Synthesis of methyl phosphinite-boranes 3 and chlorophosphine-borane 3′

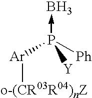

3: Y = OMe
3′: Y = Cl

| | 3a | 3b | 3c | 3d | 3e | 3′a | 3′ab |
|---|---|---|---|---|---|---|---|
| Y | OMe | OMe | OMe | — | OMe | Cl | Cl |
| o-Z(CR⁰³R⁰⁴)ₙAr— | 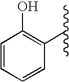 | 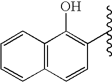 | 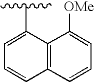 | 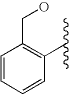 | 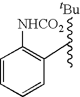 | 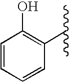 | 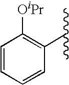 |

Y═OMe : To aminophosphine-borane 2 in MeOH (or MeOH/CH₂Cl₂) at room temperature is added (A) BF₃ etherate or BF₃ in MeOH (˜1 equiv.) or (B) anhydrous H₂SO₄ (≦1 equiv.) under stirring. Following the disappearance of 95-98% the starting material indicated by TLC, the reaction mixture is filtered on a short bed of silica gel and concentrated. The residue is partitioned between water/CH₂Cl₂, the organic layer dried over Na₂SO4, and concentrated. The residue is purified on silica gel and/or by crystallization to afford compound 3 in 85-95% yield. HPLC analysis of 3a and 3b showed >99% ee.

Y═Cl : To aminophosphine-borane 2 in aprotic solvent (as toluene, CH₂Cl₂, THF) at 0° C., a HCl solution in aprotic solvent is added. After 1 hour, ephedrine hydrochloride is filtered off on a sintered-glass filter and the filtrate concentrated to yield the chlorophosphine-borane as a viscous oil (90-95% yield).

### EXAMPLE 25

3a according to 2(A) or (B). ¹H NMR δ 0.45-1.80 (br m, 3H), 3.79 (d, 3H), 6.97 (m, 2H), 7.41-7.57 (m, 5H), 7.70 (m, 2H); ³¹P NMR δ +109.37 (m); HPLC analysis on Daicel Chiralcel® OJ (hexane/PrOH 70:30, 0.9 ml/min, λ=282 nm): t(S)=14.9 min, t(R)=22.3 min; [α]_{D}30 23.5 (c 1, MeOH).

### EXAMPLE 26

The enantiomer of 3a is prepared from the enantiomer of 2a.

### EXAMPLE 27

3b according to 2(A) or (B). ¹H NMR δ 0.66-1.87 (br m, 3H), 3.79 (d, 3H), 7.25-7.80 (m, 10H), 8.39 (d, 1H), 8.60 (s, 1H); ³¹P NMR δ +105.99 (m).

### EXAMPLE 28

3c according to 2 (B). ¹H NMR δ 0.45-1.85 (br m, 3H), 3.37 (s, 3H), 3.65 (d, 3H), 6.66 (dd, 1H), 7.32-7.50 (m, 5H), 7.57-7.68 (m, 3H), 7.99 (m, 1H), 8.26 (ddd, 1H); ³¹P NMR δ +103.65 (m).

### EXAMPLE 29

3d according to 2 (B). ¹H NMR δ 0.45-1.80 (br m, 3H), 5.55 (m, 2H), 7.38-7.68 (m, 9H); ³¹P NMR δ +124.68 (m); [α]_{D}+55.1 (c 1, CHCl₃).

### EXAMPLE 30

3e according to 2 (B). ¹H NMR δ 0.42-1.77 (br m, 3H), 1.37 (s, 9H), 3.81 (d, 3H), 7.19 (m, 1H), 7.40-7.66 (m, 7H), 7.80 (ddd, 1H), 7.93 (dd, 1H); ³¹P NMR δ+110.33 (m).

### EXAMPLE 31

3′a prepared in CH₂Cl₂ according to 2 with HCl in toluene. ¹H NMR δ 0.45-1.75 (br m, 3H), 6.89 (dd, 1H), 6.96 (dt, 1H), 7.33-7.51 (m, 4H), 7.53-7.74 (m, 3H), 8.20 (br s, 1H); ³¹P NMR δ+95.50 (m).

### EXAMPLE 32

3′ab prepared in toluene according to 2 with HCl in toluene. ¹H NMR δ 0.60-2.00 (br m, 3H), 1.00 (‘t’, 6H), 4.50 (sept, 1H), 6.85 (dd, 1H), 7.07 (dt, 1H), 7.41-7.58 (m, 4H), 7.75 (m, 2H), 8.01 (ddd, 1H); ³¹P NMR δ+91.46 (m).

### General Procedure 3: Synthesis of phosphine-boranes 4

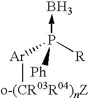

4

| | 4a | 4b | 4c | 4d | 4e | 4f |
|---|---|---|---|---|---|---|
| o-Z(CR⁰³R⁰⁴)ₙAr— | 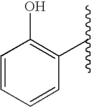 | 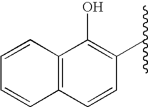 | 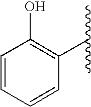 | 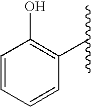 | 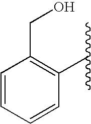 | 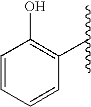 |
| R | Me | Me | 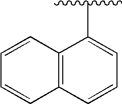 | 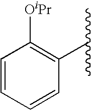 | Me | 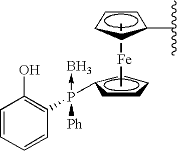 |

To a cold (−20° C.) solution of methyl phosphinite-borane 3 in THF is added under stirring (A) an oil-free NaH (1.1-1.2 equiv.) followed by the organolithium (1.0-1.1 equiv.) or (B) the oganolithium (2.0-2.1 equiv.). The resulting mixture is left to warm up to room temperature. The reaction is hydrolyzed with water after disappearance of the starting 3 as monitored by TLC. After concentration, water (or acidified water until neutral pH is reached) is added and the residue is extracted with CH₂Cl₂. Drying over Na₂SO₄, concentration and purification of the residue on silica gel and/or by crystallization affords compound 4 in 90-99% yield. A similar procedure is adopted with chlorophosphine-boranes 3′.

### EXAMPLE 33

4a according to 3(A) or (B) from 3a or from 3′a. ¹H NMR δ 0.50-1.80 (br m, 3H), 1.92 (d, 3H), 6.92 (ddd, 1H), 6.98 (tt, 1H), 7.34-7.50 (m, 5H), 7.61 (dd, 1H), 7.63 (dd, 1H); ³¹P NMR δ +4.38 (m).

### EXAMPLE 34

The enantiomer of 4a is prepared from the enantiomer of 3a.

### EXAMPLE 35

4b according to 3(A) or (B). ¹H NMR δ 0.71-1.95 (br m, 3H), 1.96 (d, 3H), 7.16 (m, 1H), 7.36-7.66 (m, 1H), 7.76 (m, 1H), 8.37 (m, 1H), 8.72 (s, 1H); ³¹P NMR δ +2.66 (m).

### EXAMPLE 36

The enantiomer of 4b is prepared from the enantiomer of 3b.

### EXAMPLE 37

4c according to 3(A) or (B). ¹H NMR δ 1.04-2.28 (br m, 3H), 6.84 (m, 2H), 7.06 (m, 1H), 7.20 (m, 1H), 7.33-7.72 (m, 9H), 7.89 (m, 1H), 8.00 (m, 1H), 8.18 (m, 1H); ³¹P NMR δ +13.96 (m).

### EXAMPLE 38

4d according to 3(A) or (B). ¹H NMR δ 0.81-2.08 (br m, 3H), 0.93 and 1.02 (2d, 6H), 4.51 (sept, 1H), 6.83-7.02 (m, 4H), 7.13 (m, 1H), 7.32-7.64 (m, 8H), 7.66 (s, 1H); ³¹P NMR δ+10.96 (m).

### EXAMPLE 39

4e according to 3(B). ¹H NMR δ 0.45-1.68 (br m, 3H), 1.89 (d, 3H), 2.19 (t, 1H), 4.40 (dd, 1H), 4.71 (dd, 1H), 7.39-7.67 (m, 9H); ³¹P NMR δ +10.70 (m).

### EXAMPLE 40

4f according to 3(A). ¹H NMR δ 0.67-2.05 (br m, 6H), 4.13, 4.54, 4.57 and 4.67 (4m, 8H), 6.81-7.01 (m, 6H), 7.31-7.48 (m, 12H), 7.59 (br s, 2H); ³¹P NMR δ +8.82 (br s).

### General Procedure 4: α-Functionalization of alkylphosphine-boranes; Synthesis of phosphine boranes 5-13

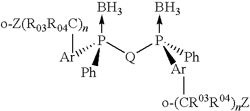

5, 6, 7, 10

| | 5a | 5b | 6a | 7a | 7ab | 10a | 12a | 12aa |
|---|---|---|---|---|---|---|---|---|
| o-Z(CR⁰³R⁰⁴)ₙAr— | 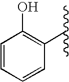 | 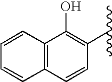 | 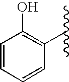 | 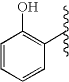 | 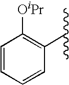 | 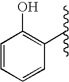 | 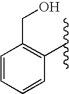 | 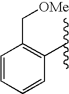 |
| Q | CH₂CH₂ | CH₂CH₂ | (CH₂)₂SiMe₂ | (CH₂)₂SiPh₂ | (CH₂)₂SiPh₂ | CH₂ | CH₂CH₂ | CH₂CH₂ |

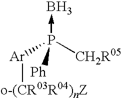

8, 9, 10, 11

| | 8a | 9a | 9ab | 10ab | 11a | 11af | 13a |
|---|---|---|---|---|---|---|---|
| o-Z(CR⁰³R⁰⁴)ₙAr— | 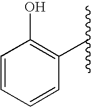 | 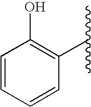 | 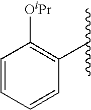 | 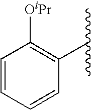 | 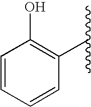 | 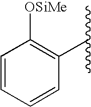 | 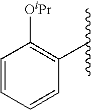 |
| R⁰⁵ | CH₂OH | P(BH₃)Ph₂ | P(BH₃)Ph₂ | 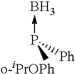 | SiMe₃ | SiMe₃ | 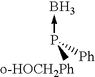 |

To a cold (0° C.) solution of phosphine-borane 4 (R=Me) in THF is added under stirring (A) an oil-free NaH (1.1-1.2 equiv.) followed by sec- or tert-BuLi (1.0-1.05 equiv.), (B) sec- or tert-BuLi (2.0-2.05 equiv.) or (C) sec- or tert-BuLi (1.0-1.05 equiv.). After leaving the resulting mixture at 0° C. for 1 h, anhydrous CuCl₂ (1.05 equiv.) or (R′R″)SiCl₂ (0.5 equiv.) is added at −30 to −40° C.; or an electrophile (0.5-1.2 equiv.) at −20 to 0° C. The reaction is left to warm up to room temperature and water (or acidified water until neutral pH is reached) is added. The mixture is concentrated, extracted with CH₂Cl₂, dried over Na₂SO₄, and concentrated. In case of reaction with CuCl₂, the residue is filtered on a bed of silica gel eluting with EtOAc. The pure product 5-13 is obtained in 65-90% yield after purification on silica gel and/or crystallization.

### EXAMPLE 41

5a according to 4(A) or (B) from 4a. ¹H NMR δ 0.43-1.78 (br m, 6H), 2.51 (m, 4H), 6.88 (m, 2H), 6.94 (br s, 2H), 6.97 (tm, 2H), 7.32-7.53 (m, 10H), 7.64 (m, 4H); ³¹P NMR δ+18.48 (m).

### EXAMPLE 42

5b according to 4(A) or (B) from 4b. ¹H NMR δ 0.70-2.10 (br m, 6H), 2.41 and 2.59 (2m, 4H), 6.98 (m, 2H), 7.27 (d, 2H), 7.38-7.65 (m, 12H), 7.75 (d, 2H), 8.32 (d, 2H), 8.60 (s, 2H); ³¹P NMR δ +11.03 (m).

### EXAMPLE 43

5ab (o-Z(R⁰³R⁰⁴C)ₙ═OⁱPr) according to 4(C) from 4ab or also according to 6(B) from 5a.

### EXAMPLE 44

6a according to 4(A) or (B) from 4a. ¹H NMR δ −0.02 (s, 6H), 0.65-1.77 (br m, 3H), 1.68 (t, 2H), 1.91 (dd, 2H), 6.85 (m, 2H), 6.95 (m, 2H), 7.40 (m, 10H), 7.61 (m, 4H); ³¹P NMR δ +7.58 (m).

### EXAMPLE 45

7ab (o-Z(R⁰³R⁰⁴C)ₙ═OⁱPr) according to 4(C) from 4ab. ¹H NMR δ 0.42-1.60 (br m, 6H), 0.73 and 1.10 (2d, 12H), 2.97 (m, 4H), 4.34 (sept, 2H), 6.52 (m, 4H), 7.05 (m, 2H), 7.15 (m, 6H), 7.34 (m, 8H), 7.54 (m, 4H); ³¹P NMR δ +14.06 (m).

### EXAMPLE 46

8a according to 4(A) or (B) from 4a and paraformaldehyde. ¹H NMR δ 0.40-1.72 (br m, 3H), 2.56 and 2.89 (2m, 2H), 3.87 (m, 2H), 6.78 (m, 1H), 6.94 (m, 1H), 7.36 (m, 4H), 7.64 (m, 3H); ³¹P NMR δ +8.13 (m).

### EXAMPLE 47

9a according to 4(A) or (B) from 4a and Ph₂PCl. In this case, after 12 hours at room temperature, BH₃.Me₂S (1 equiv.) is added at 0° C. to the mixture. After 1 hour, water is added and the mixture concentrated. The residue is extracted with CH₂Cl₂, dried over Na₂SO₄, and concentrated. The pure product is obtained in 68% yield after purification over silica gel eluting with toluene/EtOAc 20:1. ¹H NMR δ 0.20-1.55 (br m, 6H), 3.20 and 3.77 (2m, 2H), 6.74 (ddd, 1H), 6.89 (m, 1H), 7.25 (m, 1H), 7.30-7.53 (m, 10H), 7.60-7.73 (m, 6H); ³¹P NMR δ+11.01 (m), +14.62 (m).

### EXAMPLE 48

9ab according to 4(C) from 4ab, Ph₂PCl and BH₃.Me₂S as for 9a. The product is obtained in 75% yield after purification over silica gel eluting with toluene. ¹H NMR δ 0.15-1.50 (br m, 6H), 0.86 and 1.28 (2d, 6H), 3.22 and 3.91 (2m, 2H), 4.52 (sept, 1H), 6.74 (dd, 1H), 6.89 (ddt, 1H), 7.27-7.55 (m, 14H), 7.68 (m, 3H); ³¹P NMR δ +13.55(m), +14.45(m)

### EXAMPLE 49

10ab according to 4(C) from 4ab and 3′ab. ³¹P NMR δ +13.61 (m).

### EXAMPLE 50

11af according to 4(A) or (B) from 4a and 3 equiv. TMSCl. ¹H NMR δ −0.03 (s, 9H), 0.05 (s, 9H), 0.47-1.30 (br m, 3H), 1.51 (‘t’, 1H), 2.04 (dd, 1H), 6.76 (ddd, 1H), 7.08 (ddt, 1H), 7.31-7.51 (m, 6H), 8.02 (ddd, 1H); ³¹P NMR δ +12.98 (m).

### EXAMPLE 51

11a from 11af heating at 50° C. for 1 hour lla in MeOH in presence of silica gel. ¹H NMR δ 0.03 (s, 9H), 0.62-1.82 (br m, 3H), 1.53 (‘t’, 1H), 1.74 (dd, 1H), 6.88-6.98 (m, 2H), 7.31-7.47 (m, 5H), 7.60-7.68 (m, 2H); ³¹P NMR δ +6.90 (m).

### EXAMPLE 52

12a according 4(A) or (B) from 4e. ¹H NMR δ 0.45-1.80 (br m, 6H), 2.19-2.37 (m, 4H), 2.62 (m, 2H), 4.35 and 4.65 (2dd, 4H), 7.32-7.66 (m, 18H); ³¹P NMR δ +16.39 (m).

### EXAMPLE 53

13a according to 4(A) from 3d. ¹H NMR δ 0.44-1.55 (br m, 6H), 0.76 (d, 3H), 1.09 (d, 3H), 2.07 (br s, 1H), 3.07 (ddd, 1H), 3.45 (dt, 1H), 4.30 (sept, 1H), 4.59 (d, 1H), 4.85 (dd, 1H), 6.58 (dd, 1H), 6.99 (ddt, 1H), 7.09-7.62 (m, 15H), 7.94 (ddd, 1H); ³¹P NMR δ +14.58 (m), +17.32 (m).

### General Procedure 5: Other Route to phosphine-borane 4a and 5a (Scheme 3)

### EXAMPLE 54

BBr₃ (75 μl, 7 equiv.) is added to (R,R)-DiPAMP (5′aa) (50 mg, 0.11 mmol) in CH₂Cl₂ (2 ml) at −20° C. and the mixture left 1 h at room temperature. MeOH (2 ml) is added at 0° C. and the mixture refluxed for ˜2 h monitoring the reaction by ³¹P NMR. The mixture is then concentrated and carefully basified. (R,R)-5′a is extracted with a water/CH₂Cl₂ mixture, dried and concentrated. To (R,R)-5′a in THF is added Me₂S.BH₃ (2.1 equiv.) at 0° C. and the dried and concentrated. To (R,R)-5′a in THF is added Me₂S.BH₃ (2.1 equiv.) at 0° C. and the mixture left to warm up to room temperature, then concentrated and recrystallized to yield (R,R)-5a in 90% yield. ¹H and ³¹P NMR are identical to the product prepared according to 4.

### EXAMPLE 55

Similarly as above, (R)-o-(methylphenylphosphino)phenol (4′a) (108 mg, 0.5 mmol) led to (R)-o-(methylphenylphosphino-borane)phenol (4a) (109 mg) in 95% yield using BH₃.THF (1.1 equiv.). ¹H and ³¹P NMR are identical to the product prepared according to 3.

### General Procedure 6: Modification of Function Z═OH (n=0, 1) of Compounds 2-13

TABLE 1

| o-X(CR⁰³R⁰⁴)ₙAr— | R⁰⁵ | | R⁰⁵ | | R⁰⁵ | | R⁰⁵ | | R⁰⁵ | |
|---|---|---|---|---|---|---|---|---|---|---|
| 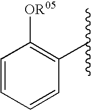 | 2a 2aa 2ab | H Me ⁱPr | 3a 3aa 3ab 3an | H Me ⁱPr Mosher: 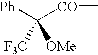 | 4f 4fb 4fbd | H ⁱPr 3-Pentyl | 4d 4dc 4dy | H CO^{t}Bu CH₂CONH^{t}Bu | 6a 6aa 6ac | H Me CO^{t}Bu |
| 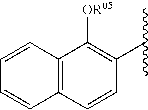 | 2b 2ba 2bc 2bd | H Me CO^{t}Bu SO₂CF₃ | 3b 3bd | H SO₂CF₃ | | | | | | |

(A) To a cold (0° C.) solution of starting 2, 3, 4, 5 or 12 (Z═OH, n=0) in THF or ether is added oil-free NaH (1.0-1.3 equiv./P*) and a reagent R⁰⁵X (1-5 equiv./P* of a mono-functional reagent and <0.5 equiv./P* for a bi-functional reagent). The mixture is stirred at room temperature until disappearance of the starting material as indicated by TLC. The concentrated mixture is extracted with CH₂Cl₂ and dried over Na₂SO₄. Concentration and purification of the residue on silica gel and/or crystallization affords the OH-functionalized compound in 75-90% yield. (B) A mixture of starting 2, 3, 4, 5 or 6 (Z═OH, n=0), a reagent R⁰⁵X (5 equiv./P* of a mono-functional reagent and <0.5 equiv./P* for a bi-functional reagent) and K₂CO₃ (3 equiv.) in acetone (or DMF) is heated at 50° C. (or refluxed) until disappearance of starting material as indicated by TLC. Insolubles are filtered off and the filtrate concentrated. Purification of the residue on silica gel and/or crystallization affords the OH-functionalized compound in 60-95% yield (Tables 1 and 2).

### EXAMPLE 56

2aa according to 6(B) from 2a and MeI. ¹H and ³¹P NMR spectra are identical to the literature.

### EXAMPLE 57

2ab according to 6(B) from 2a and isopropyl iodide. ¹H and ³¹P NMR spectra are identical to the product prepared from 1 and o-ⁱPrOPhLi according 1(A) or (B).

### EXAMPLE 58

3aa according to 6(B) from 3a and MeI. ¹H and ³¹P NMR spectra are identical to the literature.

### EXAMPLE 59

The enantiomer of 3aa is prepared from the enantiomer of 3a.

### EXAMPLE 60

3ab according to 6(B) from 3a and isopropyl iodide. ¹H NMR δ 0.20-1.77 (br m, 3H), 0.98 and 1.07 (2d, 6H), 3.71 (d, 3H), 4.47 (sept, 1H), 6.81 (dd, 1H), 7.02 (tdd, 1H), 7.34-7.51 (m, 4H), 7.74 (m, 2H), 7.84 (ddd, 1H); ³¹P NMR δ +106.30 (m).

### EXAMPLE 61

3an according to 6(A) from 3a and (R)-Moscher acid chloride. ¹H NMR δ 0.28-1.78 (br m, 3H), 3.32 (q, 3H), 3.47 (d, 3H), 7.19 (ddd, 1H), 7.31-7.70 (m, 12H), 8.04 (ddd, 1H); ¹⁹F NMR δ −71.96 (s); ³¹P NMR δ +110.25 (m).

### EXAMPLE 62

3bd according to 6(A) from 3b and triflic anhydride (Tf₂O) in ether. ¹H NMR δ 0.40-1.85 (br m, 3H), 3.86 (d, 3H), 7.41-7.57 (m, 3H), 7.63-7.83 (m, 5H), 7.90 (m, 2H), 8.17 (m, 1H); ¹⁹F NMR δ −72.06 (s); ³¹P NMR δ +112.95 (m).

### EXAMPLE 63

4aa according to 6(A) or (B) from 4a and Md. ¹H and ³¹P NMR spectra are identical to the literature. HPLC analysis on Daicel Chiralcel® OJ (hexane/ⁱPrOH 70:30, 0.9 ml/min, λ=282 nm): t(R)=14.4 min, t(S)=26.8min

### EXAMPLE 64

4ab according to 6(B) from 4a and isopropyl iodide. ¹H NMR δ 0.24-1.64 (br m, 3H), 0.90 and 1.20 (2d, 6H), 1.95 (d, 3H), 4.52 (septd, 1H), 6.82 (dd, 1H), 7.02 (m, 1H), 7.37 (m, 3H), 7.46 (m, 1H), 7.57 (m, 2H), 7.93 (ddd, 1H); ³¹P NMR δ +9.04 (m).

### EXAMPLE 65

4ad according to 6(A) from 4a and triflic anhydride (Tf₂O). ¹H NMR δ 0.30-1.70 (br m, 3H), 2.04 (d, 3H), 7.40-7.64 (m, 7H), 8.08 (ddd, 2H).

### EXAMPLE 66

4al according to 6(A) from 4a and C₆F₆ in DMF. ¹H NMR δ 0.25-1.75 (br m, 3H), 2.05 (d, 3H), 6.57 (m, 1H), 7.29 (md, 1H), 7.42 (m, 4H), 7.64 (m, 2H), 8.03 (ddd, 1H); ¹⁹F NMR δ −153.94 (d, 2F), −158.87 (t, 1F), −161.63 (m, 2F).

### EXAMPLE 67

4an according to 6(A) from 4a and (R)-Moscher acid chloride. ¹H NMR δ 0.25-1.50 (br m, 3H), 1.71 (d, 3H), 3.37 (q, 3H), 7.23-7.45 (m, 12H), 7.61 (m, 1H), 7.99 (ddd, 1H); ¹⁹F NMR δ −70.91 (s); ³¹P NMR δ +12.91 (m).

### EXAMPLE 68

4at according to 6(B) from 4a and 2,4,6-tris(bromomethyl)mesitylene. ¹H NMR δ 0.40-1.30 (br m, 9H), 1.71 (d, 9H), 1.88 (s, 9H), 4.88 and 5.02 (2d, 6H), 7.13 (m, 12H), 7.37 (m, 9H), 7.58 (m, 3H), 7.79 (m, 3H); ³¹P NMR δ +9.14 (s).

### EXAMPLE 69

4av according to 6(B) from 4a and ethyl α-bromo(dimethylacetate). ¹H NMR δ 0.50-1.80 (br m, 3H), 1.15 (t, 3H), 1.28 and 1.36 (2s, 6H), 1.96 (d, 3H), 4.14 (q, 2H), 6.52 (m, 1H), 7.05 (m, 1H), 7.35-7.58 (m, 6H), 7.91 (ddd, 1H); ³¹P NMR δ +9.85 (m).

### EXAMPLE 70

4ea according to 6(A) from 4e and Md. ¹H NMR δ 0.42-1.73 (br m, 3H), 1.89 (d, 3H), 3.10 (s, 3H), 4.20 and 4.47 (2d, 2H), 7.38-7.75 (m, 9H).

### EXAMPLE 71

4ee according to 6(A) from 4e and mesyl chloride. ¹H NMR δ 0.15-1.65 (br m, 3H), 1.92 (d, 3H), 2.75 (s, 3H), 5.13 and 5.35 (2d, 2H), 7.42-7.75 (m, 9H).

### EXAMPLE 72

5aa according to 6(B) from 5a and Md. ¹H and ³¹P NMR spectra are identical to the literature.

### EXAMPLE 73

5ai according to 6(B) from 5a and 9-(chloromethyl)anthracene. ¹H NMR δ 0.05-1.50 (br m, 6H), 2.04-2.33 (m, 4H), 5.63 (s, 4H), 6.23 (tm, 4H), 6.53 (tm, 2H), 6.71-6.84 (m, 4H), 7.12 (m, 4H), 7.29-7.48 (m, 8H), 7.55 (dt, 2H), 7.78 (dm, 4H), 7.87 (m, 2H), 7.97 (dm, 4H), 8.44 (s, 2H); ³¹P NMR δ +17.48 (m).

TABLE 2
Phosphine-boranes

| o-Z(CR⁰³R⁰⁴)ₙAr— | R⁰⁵ (R = Me) | | R⁰⁵ | |
|---|---|---|---|---|
| 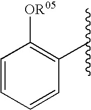 | 4a 4aa 4ab 4ac 4ad 4ae 4af 4ag | H Me (PAMP•BH₃) ⁱPr CO^{t}Bu SO₂CF₃ Ts SiⁱPr₃ CH₂SiMe₃ | 5a 5aa 5ab 5ac 5ad 5af 5ag 5ah | H Me (DiPAMP•2BH₃) ⁱPr CO^{t}Bu Ac SiⁱPr₃ CH₂SiMe₃ CH₂C₆F₅ |
| | 4ah | CH₂C₆F₅ | 5ai | 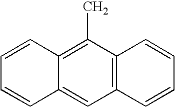 |
| | 4ai | 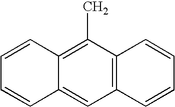 | 5aj | CH₂CO₂^{t}Bu |
| | 4aj | CH₂CO₂^{t}Bu | 5ak | P(O)(OPh)₂ |
| | 4ak | P(O)(OPh)₂ | 5abc | ⁱBu |
| | 4al | C₆F₅ | 5abd | 3-Pentyl |
| | 4am | o-CN—C₆H₄ | 5abe | Cyclohexenyl |
| | 4an | 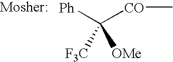 | 5abf 5abg 5ae | Cyclohexyl Cyclopentyl Ts |
| | 4av | Me₂CCO₂Et | 5acb | Benzoyl |
| | 4ax | MeC(CO₂Et)₂ | 5abh | ^{t}Bu |
| | 4ay | CH₂CONH^{t}Bu | 5akb | P(O)Ph₂ |
| | | | 5ay | CH₂CONH^{t}Bu |
| | | | 5az | Ph |
| 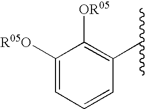 | 4abb | ⁱPr | 5abb | ⁱPr |
| 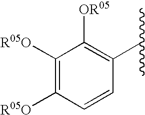 | 4abbb | ⁱPr | 4abbb | ⁱPr |
| 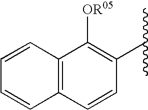 | 4b 4ba 4bc | H Me CO^{t}Bu | 5b 5ba 5bc | H Me CO^{t}Bu |
| 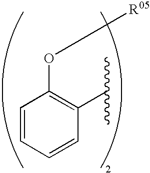 | 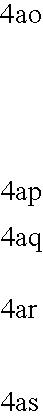 | 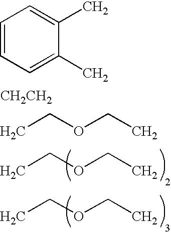 | | |
| 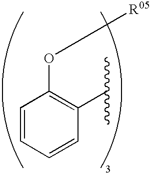 | 4at | 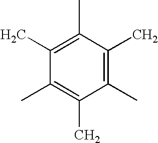 | | |

### EXAMPLE 74

5ak according to 6(A) from 5a and (PhO)₂P(O)Cl. ¹H NMR δ 0.25-1.75 (br m, 6H), 2.71 (m, 4H), 6.97 (m, 8H), 7.09-7.39 (m, 20H), 7.44 (td, 2H), 7.62 (m, 6H), 7.93 (m, 2H); ³¹P NMR δ +19.27 (m), −17.88 (s).

### EXAMPLE 75

5abe according to 6(B) from 5a and 3-bromocyclohexene. ¹H NMR δ 0.30-2.11 (m, 18H), 2.62 (m, 4H), 4.64 (br s, 2H). 5.35-5.92 (m, 4H), 6.79 (m, 2H), 6.99 (m, 2H), 2.11 (m, 18H), 2.62 (m, 4H), 4.64 (br s, 2H), 5.35-5.92 (m, 4H), 6.79 (m, 2H), 6.99 (m, 2H), 7.37 (m, 8H), 7.61 (m, 4H), 7.93 (m, 2H); ³¹P NMR δ +19.61 (m).

### General Procedure 7: Synthesis of phosphines 4′-12′

The phosphine-borane 4-12 yields the corresponding phosphine 4′-12′ after 2-12 hours in refluxing Et₂NH as solvent under inert atmosphere. After concentration and purification of the residue on silica gel and/or crystallization under inert atmosphere, the phosphine is obtained in 85-95% yield (Table 3).

TABLE 3
Phosphines

| o-Z(CR⁰³R⁰⁴)ₙAr— | R⁰⁵ (R = Me) | | R⁰⁵ | |
|---|---|---|---|---|
| 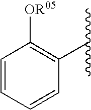 | 4′a 4′aa 4′ab 4′ac 4′ae 4′af 4′ag | H Me (PAMP) ⁱPr CO^{t}Bu Ts SiⁱPr₃ CH₂SiMe₃ | 5′a 5′aa 5′ab 5′ac 5′af 5′ag 5′ah | H Me (DiPAMP) ⁱPr CO^{t}Bu SiⁱPr₃ CH₂SiMe₃ CH₂C₆F₅ |
| | 4′ah | CH₂C₆F₅ | 5′ai | 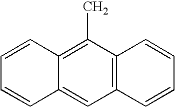 |
| | 4′ai | 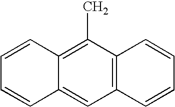 | 5′aj | CH₂CO₂^{t}Bu |
| | 4′aj | CH₂CO₂^{t}Bu | 5′ap | CH₂CH₂OMe |
| | 4′ak | P(O)(OPh)₂ | 5′abc | ^{t}Bu |
| | | | 5′abd | 3-Pentyl |
| | | | 5′abh | ^{t}Bu |
| | | | 5′abf | Cyclohexyl |
| | | | 5′abg | Cyclopentyl |
| | | | 5′ae | Ts |
| | | | 5′acb | Benzoyl |
| | | | 5′akb | P(O)Ph₂ |
| | | | 5′ay | CH₂CONH^{t}Bu |
| | | | 5′az | Ph |
| 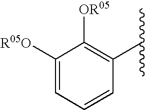 | | | 5′abb | ⁱPr |
| 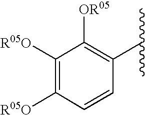 | | | 5′abbb | ⁱPr |
| 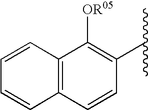 | 4′bc | CO^{t}Bu | 5′ba 5′bb 5′bc | Me ⁱPr CO^{t}Bu |
| 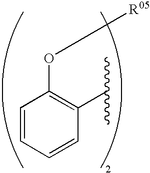 | 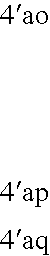 | 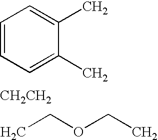 | | |

### EXAMPLE 76

4′ac according to 7 from 4ac. ¹H NMR δ 1.27 (s, 9H), 1.55 (d, 3H), 7.04 (m, 1H), 7.22 (m, 2H), 7.34 (m, 6H); ³¹P NMR δ −38.14 (s).

### EXAMPLE 77

4′ak according to 7 from 4ak. ¹H NMR δ1.54 (d, 3H), 7.10-7.54 (m, 19H); ³¹P NMR δ −17.74 (s), −36.27 (s).

### EXAMPLE 78

4′ao according to 7 from 4ao. ¹H NMR δ 1.54 (d, 6H), 4.92 (m, 4H), 6.84 (m, 2H), 6.94 (t, 2H), 7.15 (m, 2H), 7.21-7.40 (m, 16H); ³¹P NMR δ −35.81 (s).

### EXAMPLE 79

4′ap according to 7 from 4ap. ¹H NMR δ 1.58 (d, 6H), 3.85-4.15 (m, 4H), 6.77 (dd, 2H), 6.92 (t, 2H), 7.09 (m, 2H), 7.32-7.41 (m, 8H), 7.46 (m, 4H); ³¹P NMR δ −34.02 (s).

### EXAMPLE 80

4′aq according 7 from 4aq. ¹H NMR δ 1.59 (d, 6H), 3.65 (t, 4H), 4.01 (m, 4H), 6.83 (dd, 2H), 6.92 (tt, 2H), 7.08 (m, 2H), 7.31 (m, 8H), 7.44 (m, 4H); ³¹P NMR δ −35.81 (s).

### EXAMPLE 81

4′dc according 7 from 4dc. ¹H NMR δ 1.07 and 1.10 (2d, 6H), 1.13 (s, 9H), 4.48 (sept, 1H), 6.70-6.86 (m, 4H), 7.04-7.14 (m, 2H), 7.24-7.38 (m, 7H); ³¹P NMR δ −24.89 (s).

### EXAMPLE 82

4′dy according to 7 from 4dy. ¹H NMR δ 0.93 and 1.11 (2d, 6H), 1.24 (s, 9H), 4.37 (m, 2H), 4.46 (sept, 1H), 6.68 (br s, 1H), 6.70-6.95 (m, 6H), 7.25-7.39 (m, 7H); ³¹P NMR δ −25.04 (s).

### EXAMPLE 83

4′fb according to 7 from 4fb. ¹H NMR δ 0.71 and 1.19 (2d, 12H), 2.35, 3.47 and 4.12 (3m, 6H), 4.31-4.43 (m, 4H), 6.65-6.83 (m, 6H), 7.14-7.30 (m, 8H), 7.35-7.44 (m, 4H); ³¹P NMR δ −26.13 (s).

### EXAMPLE 84

4′fbd according to 7 from 4fbd. ¹H NMR δ 0.36 and 0.90 (2t, 12H), 1.22 and 1.56 (2m, 8H), 4.01 (quin, 2H), 3.43, 4.10, 4.38 and 4.42 (4m, 8H), 6.67 (dd, 2H), 6.75 (m, 4H), 7.14-7.29 (m, 8H), 7.40 (m, 4H); ³¹P NMR δ −26.67 (s).

### EXAMPLE 85

DiPMP (5′a) according to 7 from 5a. In this case, a Et₂NH adduct precipitates. ¹H NMR (DMSO-d₆) δ 1.00 (t, 6H), 1.83 and 2.18 (2m, 4H), 2.53 (q, 4H), 6.79 (m, 6H), 7.14 (m, 2H), 7.21-7.39 (m, 10H); ³¹P NMR (DMSO-d₆) δ −21.17 (s). The free diphosphine is obtained quantitatively by capture of Et₂NH by a weakly acidic resin as Amberlite® IRC-50 H in MeOH. ¹H NMR δ 2.15 (m, 4H), 6.46 (br s, 2H), 6.91 (m, 4H), 7.06 (m, 2H), 7.30 (m, 12H); ³¹P NMR δ −39.23 (s).

### EXAMPLE 86

SMS-PiP (5′ab) according to 7 from 5ab. ¹H NMR δ 1.03 and 1.17 (2d, 12H), 1.95 and 2.28 (2m, 4H), 4.47 (sept, 2H), 6.75 (dm, 2H), 6.97 (td, 2H), 7.05-7.39 (m, 14H); ³¹P NMR δ −19.13 (s).

### EXAMPLE 87

SMS-Piv (5′ac) according to 7 from 5ac. ¹H NMR δ 1.25 (s, 18H), 2.02 (m, 4H), 7.01 (m, 2H), 7.13 (m, 4H), 7.20-7.38 (m, 12H); ³¹P NMR δ −25.30 (s).

### EXAMPLE 88

5′af according to 7 from 5af. ¹H NMR δ 1.01 and 1.02 (2d, 36H), 1.22 (sept, 6H), 1.87 and 2.15 (2m, 4H), 6.75 (dm, 2H), 6.82 (td, 2H), 6.95 (m, 2H), 7.15 (m, 2H), 7.23 (m, 10H); ³¹P NMR δ −23.86 (s).

### EXAMPLE 89

5′ag according 7 from 5ag. ¹H NMR δ 0.28 (s, 18H), 2.19 and 2.54 (2m, 4H), 3.78 (s, 4H), 7.13 (dt, 2H), 7.22 (d, 2H), 7.28 (m, 2H), 7.55 (m, 12H); ³¹P NMR δ −21.25 (s).

### EXAMPLE 90

5′ah according to 7 from 5ah. ¹H NMR δ 1.83 and 2.08 (2m, 4H), 4.98 (m, 4H), 6.94 (m, 4H), 7.05-7.40 (m, 14H); ¹⁹F NMR δ −142.22 (m, 4F), −153.57 (m, 2F), −162.21 (m, 4F); ³¹P NMR δ −20.90 (s).

### EXAMPLE 91

5′aj according to 7 from 5aj. ¹H NMR δ 1.42 (s, 18H), 1.99 and 2.38 (2m, 4H), 4.42 (s, 4H), 6.65 (dm, 2H), 6.86 (td, 2H), 6.97 (m, 2H), 7.16-7.43 (m, 12H); ³¹P NMR δ −20.96 (s).

### EXAMPLE 92

5′ap according to 7 from 5ap. ¹H NMR δ 1.94 and 2.27 (2m, 4H), 3.31 (s, 6H), 3.30 (t, 4H), 3.99 (m, 4H), 6.81 (d, 2H), 6.87 (td, 2H), 7.04 (m, 2H), 7.22-7.40 (m, 12H); ³¹P NMR δ −20.24 (s).

### EXAMPLE 93

5′bb according to 7 from 5bb. ¹H NMR δ 1.30 and 1.36 (2d, 12H), 2.19 (m, 4H), 4.79 (m, 2H), 7.06 (dt, 2H), 7.22-7.56 (m, 16 H), 7.75 (m, 2H), 8.16 (m, 2H); ³¹P NMR δ −23.31 (s).

### EXAMPLE 94

5′bc according to 7 from 5bc. ¹H NMR δ 1.48 (br s, 18H), 2.14 (m, 4H), 6.83-7.85 (m, 22H); ³¹P NMR δ −27.98 (m).

### EXAMPLE 95

5′az according to 7 from 5az. ¹H NMR δ 2.06 and 2.34 (2m, 4H), 6.75 (m, 4H), 6.94-7.42 (m, 24H); ³¹P NMR δ −22.53 (s).

### EXAMPLE 96

5′abc according to 7 from 5abc. ¹H NMR δ 0.85 and 0.87 (2d, 12H), 1.88 (m, 2H), 1.96 and 2.31 (2m, 4H), 3.61 (m, 4H), 6.76 (m, 2H), 6.82 (m, 2H), 6.99 (m, 2H), 7.19-7.35 (m, 12H); ³¹P NMR δ −20.29 (s).

### EXAMPLE 97

5′abf according to 7 from 5abf. ¹H NMR δ 1.08-2.46 (m, 24H), 4.20 (m, 2H), 6.73-6.83 (m, 4H), 7.02 (m, 2H), 7.17-7.40 (m, 12H); ³¹P NMR δ −19.28 (s).

### EXAMPLE 98

5′abb according to 7 from 5abb. ¹H NMR δ 1.16-1.34 (m, 24H), 1.89 and 2.31 (2m, 4H), 4.49 and 4.76 (2sept, 4H), 6.49 (m, 2H), 6.79-6.89 (m, 4H), 7.22-7.38 (m, 10H); ³¹P NMR δ −21.43 (s).

### EXAMPLE 99

5′abbb according to 7 from 5abbb. ¹H NMR δ 1.10 (d, 6H), 1.22 (m, 18H), 1.32 (d, 6H), 1.34 (d, 6H), 1.91 (m, 2H), 2.19 (m, 2H), 4.30 (sept, 2H), 4.49 (sept, 2H), 4.87 (sept, 2H), 6.48-6.60 (m, 4H), 7.23-7.37 (m, 10H); ³¹P NMR δ −22.56 (s).

### EXAMPLE 100

5′ae according to 7 from 5ae. ¹H NMR δ 1.88 (m, 4H), 2.38 (s, 6H), 6.98 (m, 2H), 7.06-7.35 (m, 20H), 7.76 (m, 4H); ³¹P NMR δ −24.72 (s).

### EXAMPLE 101

5′acb according to 7 from 5acb. NMR ¹H δ 1.89-2.24 (m, 4H), 7.11-7.29 (m, 16H), 7.34-7.44 (m, 6H), 7.55 (m, 2H), 7.96 (m, 4H); ³¹P NMR δ −23.48 (s).

### EXAMPLE 102

5′akb according to 7 from 5akb. ¹H NMR δ 1.86-2.22 (m, 4H), 6.96 (m, 4H), 7.11-7.58 (m, 26H), 7.69 (m, 4H), 7.96 (m, 4H); ³¹P NMR δ −24.43 (s), +31.20 (s).

### EXAMPLE 103

5′abd according to 7 from 5abd. ¹H NMR δ 0.67 and 0.85 (2t, 12H), 1.44 and 1.55 (2m, 8H), 1.95 and 2.31 (2m, 4H), 4.10 (quin, 2H), 6.74 (m, 2H), 6.80 (m, 2H), 7.04 (m, 2H), 7.18-7.38 (m, 12H); ³¹P NMR δ −20.16 (s).

### EXAMPLE 104

5′abh according to 7 from 5abh. ¹H NMR δ 1.36 (s, 18H), 1.86 and 2.28 (2m, 4H), 6.82-7.02 (m, 6H), 7.17 (m, 2H), 7.22-7.35 (m, 10H); ³¹P NMR δ −19.85 (s).

### EXAMPLE 105

5′ay according to 7 from 5ay. ¹_{H NMR δ} 1.33 (s, 18H), 2.02 and 2.19 (2m, 4H), 4.27 and 4.35 (2d, 4H), 6.70 (br s, 2H), 6.80 (m, 2H), 6.98 (m, 2H), 7.09 (m, 2H), 7.31 (m, 12H); ³¹P NMR δ −24.44 (s).

### EXAMPLE 106

7′ab according to 7 from 7ab. ¹H NMR δ 0.89 and 1.03 (2d, 12H), 1.63 (d, 2H), 1.97 (d, 2H), 4.32 (sept, 2H), 6.60 (m, 2H), 6.78 (m, 2H), 7.04-7.27 (m, 20 H), 7.37 (m, 4H); ³¹P NMR δ −29.14 (s).

### EXAMPLE 107

12′aa according to 7 from 12aa. ¹H NMR δ 2.09 (m, 4H), 3.29 (s, 6H), 4.53 and 4.75 (2d, 4H), 7.16-7.47 (m, 18H); ³¹P NMR δ −24.77 (s).

### EXAMPLES OF MODIFICATION ON THE PHOSPHORUS P* ATOM

### (See Also Compounds Prepared According to 5)

### EXAMPLE 108

### Preparation of DiPAMP·2HBF₄ (5′aa 2HBF₄)

To DiPAMP (5′aa) (50 mg) in ether is added HBF₄ 50% in ether (2.2 equiv.). The white precipitate is filtered, rinsed with ether and dried under vacuo. ¹H NMR δ 3.25 (m, 4H), 3.99 (s, 6H), 7.06 (m, 2H), 7.24 (m, 2H), 7.57-7.78 (m, 8H), 7.96 (m, 6H); ¹⁹F NMR δ −149.49 (s, 1F), −149.54 (s, 3F); ³¹P NMR δ +8.39 (m).

### EXAMPLE 109

### Preparation of (SMS-PiP)·2HBF₄ (5′ab·2HBF₄)

Following the above procedure from SMS-PiP (5′ab) (50 mg). ¹H NMR δ 1.23 and 1.30 (2d, 12H) 3.25 (m, 4H), 4.68 (sept, 2H), 7.02 (m, 2H), 7.23 (m, 2H), 7.63 (m, 4H), 7.71 (m, 4H), 7.93 (m, 6H); ¹⁹F NMR δ −149.10 (s, 1F), -149.16 (s, 3F); ³¹P NMR δ +2.41 (m).

### EXAMPLE 110

### Preparation of o-(methylphenylphosphino-oxide)phenol (4′a-oxide)

To o-(methylphenylphosphino)phenol (4′a) (25 mg) in THF is added at room temperature an aqueous solution of 30% H₂O₂ (200 μl). After 10 min, the mixture is concentrated yielding quantitatively 4′a-oxide as a white solid. ¹H NMR δ 2.10 (d, 3H), 6.86 (ddt, 1H), 6.94 (ddd, 1H), 7.06 (m, 1H), 7.39 (m, 1H), 7.52 (m, 3H), 7.77 (m, 2H), 11.10 (br s, 1H); ³¹P NMR δ +43.38 (br s) ; [α]_{D} 58 (c 1, MeOH).

### Synthesis of Metal Precursors and Catalysts

All operations were conducted under Ar atmosphere with dried and degassed solvents. The metal precursors, bis(2,5-norbomadiene)rhodium tetrafluoroborate [(nbd)₂Rh]BF₄, (2,5-norbomadiene)ruthenium dichloride polymer [(nbd)RuCl₂]ₙ, and bis(2-methylallyl)(1,5-cyclooctadiene)ruthenium [(cod)Ru(C₄H₇)₂] are commercially available.

### EXAMPLE 111

### Preparation of Rhodium Catalysts Rh-L*

To a solution of [(nbd)₂Rh]BF₄ (2.8 mg, 1% Rh) in MeOH (0.5 ml), a solution of the ligand L*(2 equiv. in case of monophosphines; 0.75 equiv. with diphosphines) in MeOH (0.5 ml) or CH₂Cl₂ (0.5 ml) is added dropwise at room temperature. The mixture is hydrogenated at 1 atm H₂ for 15 min, filtered on a sintered glass, and the filtrate containing the catalyst Rh-L* is used directly in the tests. For example: Rh-(5′ab) complex prior to hydrogenation: ³¹P NMR (MeOH) δ +52.99 (d, J 158.08).

### Preparation of Ruthenium Catalysts

### EXAMPLE 112

### Preparation of (1,5-cyclooctadiene)ruthenium dihalide [(cod)RuX₂]ₓ

To a solution of [(cod)Ru(C₄H₇)₂] (160 mg, 0.5 mmol) in acetone (3 ml), a 0.2 M FIX (X═Cl, Br, I) in acetone (5 ml, 1 mmol) is added at room temperature. The [(cod)RuX₂]ₓ complexes precipitate, are filtered, rinsed with acetone and dried in vacuum (75-85% yield).

### EXAMPLE 113

### Preparation of (1,5-cyclooctadiene)(1,3,5-cyclooctatriene)ruthenium hydride trifluoromethanesulfonate [(cod)(cot)RuH]OTf

To a cold (0° C.) solution of [(cod)Ru(C₄H₇)₂] (160 mg, 0.5 mmol) and 1,5-cyclooctadiene (185 μl, 1.5 mmol) in ether (3 ml) is slowly added triflic acid (44 μl, 0.5 mmol). The [(cod)(cot)RuH]OTf precipitates, is filtered, rinsed with ether and dried (185 mg, 80% yield).

### Testing of Ligands L* and Catalysts in Asymmetric Catalysis

### EXAMPLES 114-162

### Procedure for Hydrogenation of Olefins

To a solution of the substrate (0.5 mmol) in MeOH (7 ml), a solution of the Rh-L* catalyst in MeOH (prepared as above) is added under Ar, then a vacuum/H₂ cycle is applied. The mixture is stirred at room temperature under 1 atm of H₂ (10 bars for atropic acid) until uptake H₂ ceased. The solution is analyzed by GC on Lipodex E, Chiralsil-L-Val, CP-Chiralsil DEX CB columns. The acids were esterified in CH₂Cl₂ using TMSCH₂N₂ (hexanes) prior to analysis ²⁵ (Tables 4, 5 and 6). The results show that using the ligands of the present invention, it is possible to significantly increase the reaction rate and the ee of the product.

TABLE 4

| Example | Substrate | Ligand | Cat. (%) | Time (min) | Conv. (%) | Ee (%) |
|---|---|---|---|---|---|---|
| Reference 114 115 116 117 | 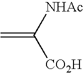 | DiPAMP 5′ab 5′ac 5′abh 5′bc | 0.1 0.1 0.1 0.1 0.1 | 11 5 5 5 5 | 100 100 100 100 100 | 90.7 98.6 99.0 99.0 97.9 |
| Reference 118 119 120 121 122 123 | 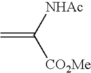 | DiPAMP 5′ab 5′ac 5′af 5′ah 5′bc 5′abd | 0.1 0.1 0.1 1 0.1 0.1 0.1 | 15 7 5 5 6 5 5 | 100 100 100 100 100 100 100 | 93.6 99.4 99.6 99.3 99.0 98.5 99.9 |

TABLE 5

| Example | Substrate | Ligand | Cat. (%) | Time (min) | Conv. (%) | Ee (%) |
|---|---|---|---|---|---|---|
| Reference 124 125 126 127 128 | 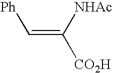 | DiPAMP 5′ab 5′ac 5′ah 5′bc 4′fb | 1 1 1 1 1 1 | 20 5 10 7 9 3 | 100 100 100 100 100 100 | 92.9 99.6 99.6 99.2 99.3 99.4 |
| Reference 129 Reference 130 131 132 133 134 135 136 137 138 | 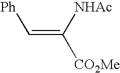 | PAMP 4′ab DiPAMP 5′a 5′ab 5′ac 5′ah 5′bc 5′abc 5ag 4′fb 5′abb | 1 1 1 1 1 1 1 1 1 1 1 1 | 15 3 20 150 5 9 7 9 4 5 4 3 | 100 100 100 99 100 100 100 100 100 100 100 100 | 22.6 35.0 94.9 94.7 99.7 99.7 99.4 99.2 99.7 99.7 99.2 99.2 |
| Reference 139 140 141 142 | 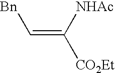 | DiPAMP 5′ab 5′ab 5′abh 5′abb | 1 1 0.1 1 1 | 15 4 40 4 3 | 100 100 100 100 100 | 96.1 98.8 98.5 98.5 99.1 |
| Reference 143 | 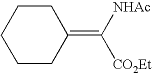 (5-10 bars) | DiPAMP 5′ab | 1 1 | 60 60 | 100 100 | 95.5 99.2 |

TABLE 6

| Example | Substrate | Ligand | Cat. (%) | Time (min) | Conv. (%) | Ee (%) |
|---|---|---|---|---|---|---|
| Reference 144 145 146 | 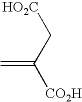 | DiPAMP 5′ab 5′ac 5′abh | 1 1 1 1 | 60 5 6 20 | 40 100 100 100 | 11.0 98.2 98.5 99.3 |
| Reference 147 148 149 | 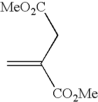 | DiPAMP 5′ab 5′abf 5′abb | 1 1 1 1 | 10 8 8 7 | 100 100 100 100 | 85.3 97.4 98.1 96.7 |
| Reference 150 151 152 | 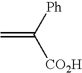 (10 bars) | DiPAMP 5′ab 5′abf 5′abb | 1 1 1 1 | 180 120 120 120 | 100 100 100 100 | 6.8 79.3 87.1 90.3 |
| Reference 153 154 | 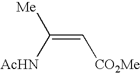 | DiPAMP 5′ab 5′ah | 1 1 1 | 330 30 45 | >99 100 97 | 65.8 82.1 72.7 |
| Reference 155 156 | 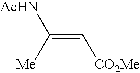 | DiPAMP 5′ab 5′ah | 1 1 1 | 330 120 120 | >99 95 95 | 87.0 90.4 90.3 |
| Reference 157 158 | 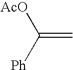 | DiPAMP 5′ab 5′bb | 1 1 1 | 60 45 120 | >99 100 >99 | 59.1 92.8 82.4 |
| Reference 159 160 161 162 | 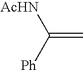 | DiPAMP 5′ab 4′fb 5′abb 5′abc | 1 1 1 1 1 | 13 5 20 3 10 | 100 100 100 100 100 | 84.0 99.0 96.6 99.7 97.7 |

### EXAMPLES 163-166

### Procedure for Hydrogenation of Ketones with Ru-L* Catalysts

TABLE 7

| | | | | | p | T | Time | Conv. | Ee |
|---|---|---|---|---|---|---|---|---|---|
| Example | Substrate | Ligand | Precursor | Method | (bar) | (° C.) | (h) | (%) | (%) |
| Reference 163 164 165 | 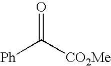 | DiPAMP 5′ab 5′ab 5′af | [(cod)RuBr₂]₂ [(cod)RuBr₂]₂ [(cod)RuBr₂]₂ [(cod)RuBr₂]₂ | A A A A | 60 60 90 90 | 35 35 40 40 | 16 16 16 16 | 9 45 87 96 | 6.9 47.5 53.6 45.7 |
| Reference Reference Reference Reference Reference 166 | 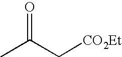 | DiPAMP DiPAMP DiPAMP DiPAMP DiPAMP 5′ab | [(cod)RuCl₂]₂ [(cod)RuCl₂]₂ [(cod)RuI₂]₂ [(cod)Ru(OTf)₂]₂ [(cod)RuBr₂]₂ [(cod)Ru(OTf)₂]₂ | A B B A A A | 60 60 60 20 20 20 | 50 50 50 20 20 20 | 16 16 16 16 16 16 | 22 54 49 95 19 100 | 0.9 23.1 45.0 28.3 40.7 26.7 |

A) A solution of [(cod)RuX₂]ₓ (10 μmol) (prepared as above) and the L* (10 μmol) in acetone (1 ml) is stirred for 30 min at room temperature then concentrated. A solution of the substrate (1 mmol) in MeOH (2 ml) is added and the solution is hydrogenated as indicated. B) To a mixture of [(cod)Ru(C₄H₇)₂] (3.2 mg, 10 μmol) and the L* (10 μmol) in acetone (1 ml), a solution of 0.22 M HX (22 μmol, 2.2 equiv.) (X═Cl, Br, I) in MeOH (100 μl) is added at room temperature. After stirring for 30 min, the mixture is concentrated. To the residue is added a solution of the substrate (1 mmol) in MeOH (2 ml). The mixture is hydrogenated as indicated in table 7. The crude is analyzed by GC on CP-Chiralsil DEX CB.

### EXAMPLE 167

### Procedure for Hydrogenation of Ketones with DPEN-Ru-L* Catalysts

A mixture of [(cod)RuCl₂]₂ (2.8 mg, 5 μmol, as described above) and the ligand L* (10 μmol) in acetone (0.5 ml) is stirred for 30 min at 40° C. and concentrated. The residue is transferred in DMF (0.5 ml) to 1,2-diphenylethylenediamine (DPEN) (2.1 mg, 10 μmol) and stirred for 1 h before concentration. A solution of acetophenone (120 mg, 1 mmol) and ^{t}BuOK (3.4 mg, 30 μmol) in ⁱPrOH (1 ml) is added and hydrogenated at room temperature under 10 bars for 3 h. The crude is analyzed by GC on CP-Chiralsil DEX CB at 120° C.: t(R)=6.5 min, t(S)=7.0 min

TABLE 8

| Example | Substrate | Ligand | DPEN | Conv. (%) | Ee (%) |
|---|---|---|---|---|---|
| Reference | 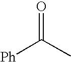 | (R,R)-DiPAMP (R,R)-5′ab | 1S,2S 1S,2S | 99 100 | 29.7 (R) 34.0 (R) |

### EXAMPLE 168

### Procedure for Hydrosilylation of Ketones

To a solution of [(nbd)₂Rh]BF₄ (1.9 mg, 5 μmol) in THF (0.5 ml), a solution of the L* (1.1 equiv. to Rh atom) in THF (0.5 ml) is added at room temperature and the mixture stirred for 15 min Acetophenone (58 μl, 0.5 mmol) is added at 0° C. then Ph₂SiH₂ (138 μl, 0.75 mmol). After 2.5 h, K₂CO₃ (0.5 mg) in MeOH (0.5 ml) is added and the mixture stirred at room temperature for 3 h, then concentrated. The crude is analyzed on CP-Chiralsil DEX CB.

TABLE 9

| Example | Substrate | Ligand | Time (min) | Conv. (%) | Ee (%) |
|---|---|---|---|---|---|
| Reference 168 | 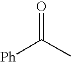 | DiPAMP 5′ab | 150 150 | 93 82 | 17.3 30.3 |

1) New optically active organic phosphorus compounds where the phosphorus atom is a bearer of chirality and of a (hetero)aryl group functionalized in 2- or ortho-position to the phosphorus atom, characterized by the general formula (I), 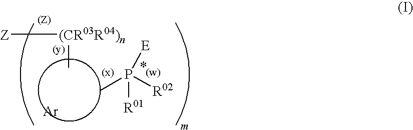
wherein:
m is an integer higher or equal to 1, n is a number equal to 0 or 1,
P* symbolizes an asymmetric phosphorus atom,
E represents an electron pair (2e⁻), a borane (BH₃), or an acid such as HBF₄, TfOH, HClO₄, HPF₆, HBr, HI, HCl, HF, AcOH, CF₃CO₂H, MsOH,
R⁰³ and R⁰⁴ represent independently from one another a hydrogen atom, a C₁₋₄ alkyl or C₁₋₄ alkoxy group optionally substituted with fluorine atoms and/or other C₁₋₄ alkyl or alkoxy groups optionally substituted; or may be linked together to form a ring, as a C₅₋₆ cycloalkane, a dioxolane, a dioxane, or bonded to Ar to form for example a naphth-1,8-diyl optionally substituted;
(z) indicates the bond established between the group (CR⁰³R⁰⁴), and Z, and when n=0, then (y) indicates the bond established between Ar and Z,
Ar symbolizes a C₄₋₁₄ aromatic or polyaromatic group linked to P* atom by (x) bond and to Z—(CR⁰³R⁰⁴) group by (y) bond in such a way that the Z—(CR⁰³R⁰⁴)ₙ group is in 2- or ortho-position to the P* atom; Ar includes or not one or several heteroatoms such as N, O, S, or may optionally bear one or several heteroatoms such as N, O, Si, halogen, and/or Ar may be optionally substituted with one or several C₁₋₁₀ alkyls and/or alkoxys also optionally substituted or forming a cycle between themselves; in such a way that the phosphino-Ar may represent a phosphinobenzene, 1-phosphinonaphthalene, 2-phosphinonaphthalene, N—(R⁰⁵)-2-methyl-7-phosphinoindole, N—(R⁰⁵)-7-phosphinoindoline, or Z—(CR⁰³R⁰⁴)ₙ)—Ar-phosphino may represent a N—(R⁰⁵)-2-phosphinopyrrole or N—(R⁰⁵)-2-phosphinoindole, wherein N—(R⁰⁵) represents a nitrogen atom linked to a hydrogen, a C₆₋₁₄ aryl group as 1-naphthyl optionally substituted, a C₁₋₁₈ alkyl, an aryl-alkyl or alkoxycarbonyl as tert-butoxycarbonyl, optionally substituted with alkyls, alkoxys and/or heteroatoms such as N, P or F,
Z represents a group OR⁰⁵, SR⁰⁵, SO₂R⁰⁵, N(R⁰⁶R⁰⁷), C(O)N(R⁰⁶R⁰⁷), N—(R⁰⁵), and with m=1, (CR⁰³R⁰⁴)ₙ═CH₂, Z may also represent a branched C₅₋₇ alkyl or cycloalkyl optionally substituted with C₁₋₁₀ alkyls or C₅₋₁₄ aryls; or also may represent a C₁₋₁₀ trialkylsilyl group, triphenylsilyl, a C₅₋₁₄ (hetero) aryl, optionally substituted with fluorine atoms or C₁₋₁₀ alkyls,
with m≧2, Z may represent a R⁰⁵ group linked at end-of-chain(s) to O-, S-, N-, NC(O)-termini, optionally interrupted by heteroatoms such as N, O, S, Si, P; or also R⁰⁵ may represent a chiral hydrocarbon chain, a polymer, a resin, a gel, a siloxane, or a spacer between these and the O-, S-, N-, NC(O)-termini; for instance R⁰⁵ may represent a skeleton of formula (II), 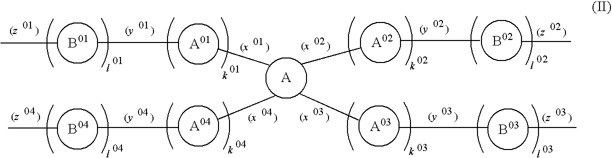
wherein:
A symbolizes a carbon, O, or S atom or a Ts-N, CH, CH₂, (—Si(R⁰⁵′)₂O—Si(R⁰⁵′)₂)_{m′} group, an arene as benzene, pyridine, wherein R⁰⁵′ represents a C₁₋₁₀ alkyl and m′ is an integer higher or equal to 1,
A⁰¹, A⁰², A⁰³, A⁰⁴ independently from one another symbolize a CH₂, (R⁰⁵′)CH wherein R⁰⁵′ represents a C₁₋₁₀ alkyl,
B⁰¹, B⁰², B⁰³, B⁰⁴ independently from one another symbolize a CH₂, C(O), SO_{2,} (R⁰⁸_{R}⁰⁹)Si, C(O)N, C(O)O, wherein R⁰⁸ and R⁰⁹ represent independently from one another a C₁₋₁₈ alkyl, a C₅₋₈ cycloalkyl or C₆₋₁₀ aryl optionally substituted with alkyls, alkenyls or aryls, and/or contain heteroatoms as O, N, Si, P, halogen,
k⁰¹,k⁰², k⁰³, k⁰⁴ independently from one another are integers varying from zero to 10, and l⁰¹, l⁰², l⁰³, l⁰⁴ are independently from one another integers varying from zero to 1,
(x⁰¹), (x⁰²), (x⁰³), (x⁰⁴) indicate the bonds established respectively between A and A⁰¹, A⁰², A⁰³, A⁰⁴, and when k⁰¹, k⁰², k⁰³ or k⁰⁴ A and when k⁰¹, k⁰⁴ equals zero, then (x⁰¹), (x⁰²), (x⁰³), (x⁰⁴) indicate the bonds established respectively between A and B⁰¹, B⁰², B⁰³, B⁰⁴,
(y⁰¹), (y⁰²), (y⁰³), (y⁰⁴) indicate the bonds established respectively between A⁰¹, A⁰², A⁰³, A⁰⁴ and B⁰¹, B⁰², B⁰³, B⁰⁴,
(z⁰¹), (z⁰²), (z⁰³), (z⁰⁴)) indicate the bonds established respectively between B⁰¹, B⁰², B⁰³, B⁰⁴ and the O-, S-, N-, NC(O)-termini, and when l⁰¹, l⁰², l⁰³ or l⁰⁴ quals zero, then (y⁰¹), (y⁰²), (y⁰³), (y⁰⁴) indicate the bonds established respectively between A⁰¹, A⁰², A⁰³, A⁰⁴ and the O-, S-, N-, NC(O)-termini, and when k⁰¹ and l⁰¹, k⁰² and l⁰², k⁰³ and l⁰³, or k⁰⁴ and l⁰⁴ equal zero,) then (x⁰¹), (x⁰²), (x⁰³), (x⁰⁴) indicate the bonds established between A and the O-, S-, N-, NC(O)-termini; for example, with m≧2, R⁰⁵ may be a Merrifield or a Wang resin, a (CH₂)₂, (CH₂)₃, (—CH₂CH₂)₂O, (—CH₂CH₂)₂NTs, α,α′-o-xylyl, 2,6-bis(methylene)pyridine, 1,2,4,5-(tetramethylene)benzene, diglycolyl, phthaloyl, trimesoyl, 2,6-(pyridine)dicarbonyl, (benzene)disulfonyl, 1,2-bis(dialkylsilypethane, bis(dialkylsilyl)oxy,
with m=1:
OR⁰⁵ represents a negatively charged oxygen atom, a hydroxy, a C₁₋₁₈ alkoxy, straight or branched, cyclic or polycyclic, saturated or unsaturated, optionally substituted with one or several C₄₋₁₄ (hetero) aryls—all these groups possess or not one or several asymmetric carbon atoms symbolized by C*; or also OR⁰⁵ represents a C₅₋₁₄ (hetero) aryloxy optionally containing fluorine atoms, one or several nitro, cyano, trifluoromethyl groups and the like; R⁰⁵ optionally substituted with heteroatoms such as O, N, Si, halogen as fluorine, and/or a functional group such an unsaturation, a hydroxy, amino, (di)alkylamino, carboxy, ester, amide, ammonium, sulfonate, sulfate, phosphite, phosphonate, phosphate, phosphine or their derivatives; OR⁰⁵ represents also a C₁₋₃₆ acyloxy, a C₄₋₁₄ (hetero) aroyloxy, optionally chiral and/or substituted by heteroatoms and/or alkyls; or OR⁰⁵ represents a silyloxy group, a sulfate or sulfonate containing an alkyl, aryl or heteroaryl optionally substituted with fluorine, O, N atoms, alkyls and/or aryls; or also OR⁰⁵ (chiral or not) represents a phosphinite, phosphonite, phosphate, phosphite, phosphinate, phosphonate, borate, urethane or sulfamic ester; OR⁰⁵ may also form a cycle with Ar for example a 2,3-dihydro-2,2-dimethyl-7-benzofuranyl or a group of formula (Ia): 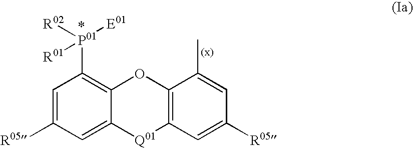
wherein:
P⁰¹* symbolizes an asymmetric phosphorus atom with P* and P⁰¹* atoms having identical absolute configurations,
(x) indicates the bond established between the group (Ia) and P*,
E⁰¹ represents independently from E what was previously defined for E,
Q⁰¹ symbolizes a C(Me)₂ or Si(Me)₂ group,
R⁰⁵″ represents a hydrogen atom, a C₁₋₁₀ group as methyl or tert-butyl,
R⁰¹ and R⁰² have the same signification as in the formula (I) and are defined here below,
in SR⁰⁵, R⁰⁵ is as defined previously and in particular a hydrogen, an isopropyl, tert-butyl or C₆₋₁₀ aryl optionally substituted with one or several C₁₋₁₀ alkyl groups, C₅₋₁₀ aryl, or with heteroatoms such as O, N, Si, halogen,
in SO₂R⁰⁵, R⁰⁵ represents an isopropyl, tert-butyl or C₅₋₆ cycloalkyl, a dialkylamino,
in N(R⁰⁶R⁰⁷), R⁰⁶ and R⁰⁷ represent independently from one another what was defined previously for R⁰⁵ and in particular a hydrogen, a C₁₋₁₀ straight or branched chain, a C₅₋₈ cycloalkyl, or also R⁰⁶ and/or R⁰⁷ may be linked with Ar (n=0) to form a cycle (for example a 2-methylindol-7-yl, carbazol-1-yl), or linked with each other (n=0 or 1) to form a C₄₋₇ cycle; or also R⁰⁶ or R⁰⁷ represent a C₁₋₃₆ acyl, C₄₋₁₄ aroyl, C₁₋₁₀ alkoxycarbonyl, a sulfonyl optionally substituted; all these groups possess or not one or several asymmetric carbon atoms symbolized by C*; or also N(R⁰⁶R⁰⁷) may form a salt with a mineral or organic acid, a quaternary ammonium with activated C₁₋₁₀ alkyls, or form a borane complex,
in C(O)N(R⁰⁶R⁰⁷), R⁰⁶ and R⁰⁷ represent independently from one another what was defined previously for R⁰⁵ and in particular a hydrogen, a C₁₋₁₀ straight or branched chain, a C₅₋₈ cycloalkyl; or R⁰⁶ and R⁰⁷ may be linked to each other to form a C₄₋₇ cycle optionally substituted; or also C(O)N(R⁰⁶R⁰⁷) represent an oxazoline substituted in position 4 by one or two C₁₋₆ alkyl or aryl groups,
R⁰¹ represents a hydrogen, a halogen as Cl, Br, I or F, a C₁₋₁₈ alkyl, C₅₋₇ cycloalkyl, C₄₋₁₄ aryl or heteroaryl, optionally substituted with one or several alkyl, alkoxy or aryl groups and/or with heteroatoms such as O, N, Si, P, halogen; or also R⁰¹ represents a C₅₋₁₄ aryloxy group, C₁₋₁₈ alkoxy—possessing or not one or several asymmetric carbon atoms symbolized by C* or substituted with one or several halogens—, an amino group being a part of a C₄₋₆ aliphatic cycle, or a C₁₋₁₈ (di)alkylamino—wherein the alkyls, different or identical, possess or not one or several asymmetric carbon atoms symbolized by C* and optionally substituted with heteroatoms—; R⁰¹ represents also a Z′—(CR⁰³′R⁰⁴′)_{n′}—Ar′ group as defined here below and different from Z—(CR⁰³R⁰⁴)ₙ—Ar,
R⁰² is different from R⁰¹ and represents a C₁₋₁₈ alkyl, C₅₋₇ cycloalkyl, C₄₋₁₄ aryl or heteroaryl, optionally substituted by one or several alkyl, alkoxy, aryl groups and/or heteroatoms such as O, N, Si, P, halogen; R⁰² represents also a vinyl; in the particular case where R⁰² may represent an alkoxy group, R⁰¹ and R⁰² are linked to each other and form a C₂₋₃ aminoalkoxy hydrocarbon chain containing one or several asymmetric carbon atoms C*; or also R⁰² represents a skeleton of general formula (I′) linked to P* atom of (I) by (w) bond, 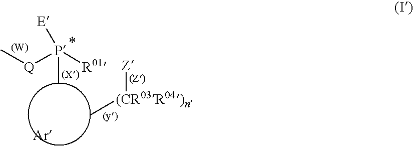
wherein:
n′ is a number equal to zero or 1,
P′* symbolizes an asymmetric phosphorus atom,
E′ represents independently from E what was defined previously for E, and E′ represents as well an oxygen atom,
R⁰³′ and R⁰⁴′ represent independently from one another and from R⁰³ and R⁰⁴ what was defined previously for R⁰³ and R⁰⁴,
Ar′ symbolizes a C₄₋₁₄ aromatic or polyaromatic group linked to P′* atom by (x′) bond and to Z′—(CR⁰³′R⁰⁴′)^{n′} group by (y′) bond in such a way that Z′—(CR⁰³′R⁰⁴′)_{n′} group is in 2- or ortho-position of P′* atom, and Ar′ represents independently from Ar what was defined previously for Ar,
(z′) indicates the bond established between (CR⁰³′R⁰⁴′)^{n′} group and Z′, and when n′=0, then (y′) indicates the bond established between Ar′ and Z′,
Z′ represents independently from Z what was defined previously for Z,
R⁰¹′ represents independently from R⁰¹ what was defined previously for R⁰¹,
Q represents a hydrocarbon chain interrupted optionally by heteroatoms as —C(R⁰⁸R⁰⁹)—, (—CH(R⁰⁸))₂ (in this case, the R⁰⁸ groups may be linked to form a cycle optionally substituted), (—CH(R⁰⁸))₂CH₂, (—CH₂)₂Si(R⁰⁸R⁰⁹), (—CH₂)₂P(E″)(R⁰⁸), —CH(R⁰⁸)CH₂CH₂CH(R⁰⁸)—, (—CH(R⁰⁸)CH₂)₂O, (—CH(R⁰⁸)CH₂O)₂P(E″)(R⁰⁸), or also 1,2-phenylene, ferrocene-1,1′-diyl, 2,6-bis(dimethylene)pyridine, N—(R⁰⁵)-pyrrolidine-3,4-diyl; wherein N—(R⁰⁵)—, R⁰⁸ and R⁰⁹ represent as described previously, and E″ represents independently from E and E′ what was defined previously for E and also an O atom,
excluding compounds of formula (I) where m=1 with the following significations:
with E representing 2e⁻ or BH₃: Z—(CR⁰³R⁰⁴)ₙ—Ar represents an o-anisyl; R⁰¹ represents a phenyl or methyl,
R⁰² represents a methyl, cyclohexyl, cyclopentadienyl, phenyl, 1-naphthyl, 2-naphthyl, halogen, 1-(2-hydroxy)ethyl, 1-(2-amino-2-phenyl)ethyl, alkoxy, aryloxy, (di)alkylamino, a (alkanesulfonyl)methyl group or (N,N-dialkylaminosulfonyl)methyl,
with E representing 2e⁻ or BH₃: R⁰¹ represents a phenyl; R⁰² represents an o-anisyl,
Z—(CR⁰³R⁰⁴)ₙ—Ar represents 2-(hydroxy)-1-naphthyl, 2-(O-acetyllactoxy)-1-naphthyl, 2-(O-diphenylphosphino-E⁰²)oxy-1-naphthyl where E⁰² represents 2e⁻ or BH₃,
with E representing 2e⁻: R⁰¹ represents phenyl; R⁰² represents methyl,
Z—(CR⁰³R⁰⁴)ₙ—Ar represents 2-methoxy-1-naphthyl, 2-acetoxy-1-naphthyl,
with E representing 2e⁻ or HBr: R⁰¹ represents phenyl; R⁰² represents methyl,
Z—(CR⁰³R⁰⁴)ₙ—Ar represents 2-hydroxyphenyl, 2-(3,3′,5,5′-tetra-tert-butyl-1,1′-bisphenyl-2,2′-phosphite)phenyl, 2-(3,3′-di-tert-butyl-5,5′,6,6′-tetramethyl-1,1′-bisphenyl-2,2′-phosphite)phenyl, 2,7-di-tert-butyl-9,9-dimethyl-5-(methylphenylphosphino-E⁰²)xanth-4-yl where E⁰² represents 2e⁻, BH₃ or O,
with E representing 2e⁻; Z—(CR⁰³R⁰⁴)ₙ—Ar is 2-camphanoxy-5-methylphen-1-yl,
R⁰¹ represents phenyl; R⁰² represents isopropyl,
with E representing 2e⁻:
Z—(CR⁰³R⁰⁴)ₙ—Ar represents an oxazoline substituted on position 4 by methyl, isopropyl, tert-butyl, phenyl,
R⁰¹ represents a phenyl; R⁰² represents 1-naphthyl, 2-naphthyl, 2-biphenylyl,
with E and E′ identical representing 2e⁻ or BH₃: Q represents CH₂CH₂,
Z—(CR⁰³R⁰⁴)ₙ—Ar and Z′—(CR⁰³′R⁰⁴′)_{n′}—Ar′ identical represent an o-anisyl,
R⁰¹ and R⁰¹′ identical and represent ethyl, cyclohexyl, phenyl, 2-naphthyl, anisyl, chlorophenyl, (methanesulfonyl)phenyl, p-(N,N-dimethylamino)phenyl, thioanisyl,
with E and E′ identical representing 2e⁻: Q represents CH₂CH₂,
R⁰¹ and R⁰¹′ identical and represent phenyl,
Z—(CR⁰³R⁰⁴)ₙ—Ar and Z′—(CR⁰³′R⁰⁴′)_{n′}—Ar′ identical represent o-hydroxyphenyl, o-thio-anisyl, o-(methanesulfonyl)phenyl, o-acetyl-phenyl, 2-methoxy-4-(sodium sulfonyl)-phenyl, 2-methoxy-4-(N,N-dimethylaminosulfonyl)phenyl,
with E and E′ identical representing 2e⁻ or BH₃:
Z—(CR⁰³R⁰⁴)ₙ—Ar and Z′—(CR⁰³′R⁰⁴′)_{n′}—Ar′ identical represent an o-anisyl,
R⁰¹ and R⁰¹′ identical and represent phenyl,
Q represents CH₂SiMe₂CH₂, CH₂SiPh₂CH₂, CH₂SiBn₂CH₂, 1,1′-ferrocenyl, 2,6-bis(dimethylene)pyridine, N—(R⁰⁵)-pyrrolidine-3,4-diyl.

2) Compounds according to claim 1 characterized by having:
an enantiomeric excess (ee) at least 95%,
m equals 1, and n equals zero or 1,
the P* and P′* atoms have the same absolute configuration,
R⁰³ and R⁰⁴ represent a hydrogen atom or bonded to Ar to form a cycle for example a naphth-1,8-diyl optionally substituted,
Ar is an aromatic group such as Z—(CR⁰³R⁰⁴)ₙ—Ar represents a 2-(neopentyl)phenyl, 2-(isobutyl)phenyl, 2-(cyclohexylmethyl)phenyl, 2-R⁰⁵O-phenyl or 2-hydroxyphenyl optionally substituted by one or several C₁₋₁₀ alkyls and/or alkoxys optionally substituted, 1-R⁰⁵O-naphth-2-yl, 1-naphthol-2-yl, 2-R⁰⁵O-naphth-1-yl, 2-naphthol-1-yl, thiophenol-2-yl, 2-(thio-isopropoxy)phenyl, 2-(thio-tert-butoxy)phenyl, 2-(2′-propanesulfonyl)phenyl, 2-(tert-butylsulfonyl)phenyl, 2-(hydroxymethyl)phenyl, 2-(R⁰⁵O-methyl)phenyl, 2-(R⁰⁶R⁰⁷)N-phenyl, 2-(N,N-diisopropylaminomethyl)phenyl, 2-(N,N-dicyclohexylaminomethyl)phenyl, 2-(N,N-diisopropylamido)phenyl, 2-(4′,4′-dimethyloxazoline)phenyl, N—(R⁰⁵)-2-methylindol-7-yl, N—(R⁰⁵)-indolin-7-yl, N—(R⁵)-pyrrol-2-yl, N—(R⁰⁵)-indol-2-yl, wherein R⁰⁵, R⁰⁶, R⁰⁷ and N—(R⁰⁵) are as defined previously,
in OR⁰⁵, R⁰⁵ represents a negative charge, a hydrogen atom, isopropyl, iso- sec- or tert-butyl, 3-pentyl, neopentyl, 2-methyl-but-3-yl, C₃₋₉ (cycloalkyl)methyl or cycloalkyl, 7-norbornadienyl, 7-norbornenyl, 7-norbornyl, allyl, methylallyl, 2-(alkoxycarbonyl)allyl, cyclohexene-3-yl, propargyl, methoxymethyl (MOM), (2-methoxyethoxy)methyl (MEM), 2-(trimethylsilyl)ethoxymethyl (SEM), 2-methoxyethyl, α-tetrahydropyranyl, arabino-, gluco-, or galacto-pyranosyl and acylated derivatives, glycidyl, (trimethylsilyl)methyl, bis(trimethylsilyl)methyl, 1-(trifluoromethyl)ethyl, a —(CH₂)_{m′}—R_{f} group (wherein m′=1, 2 or 3, R_{f} is a C₁₋₁₀ perfluoroalkyl), 2,2-dimethyl-1,3-dioxolane-4-methylene, bisprotected alanine-β-yl, benzyl, pentafluorobenzyl, 9-anthrylmethyl, 2-cyanobenzyl, 2-methoxybenzyl, 2-nitrobenzyl, 1-naphthylmethyl, dimethoxybenzyl, 2-phenylbenzyl, α-(methyl)benzyl, α-(alkoxycarbonyl)benzyl, 2-pyridylmethyl, 2-hydroxyethyl, 2-aminoethyl, sodium 2-(sulfonate)ethyl, phenyl, pentafluorophenyl, 2-cyanophenyl, 2-(trifluoromethyl)phenyl, 1-phenyl-1H-tetrazol-5-yl, isopropylcarbonyl, C₃₋₉ cycloalkanoyl, pivaloyl, triisopropylacetyl, α-alkoxy-, α-aryloxy- or α-N-tosyl-aminoacetyl optionally α-substituted with an alkyl or aryl, N-(trifluoroacetyl)prolyl, α-methoxy-α-(trifluoromethyl)phenylacetyl, O-acetyllactyl, α-acetoxyisobutyryl, α-(acetyl)acetyl, α-(alkoxycarbonyl)acetyl, camphanoyl, benzoyl, 2,4,6-trimethylbenzoyl, 2,4,6-triisopropylbenzoyl, 1-naphthoyl, 2-naphthoyl, 2-bromobenzoyl, 2-iodobenzoyl, 2-cyanobenzoyl, 2-trifluoromethylbenzoyl, 2-nitrobenzoyl, O-acetylsalicyloyl, dimethoxybenzoyl, 2-phenoxybenzoyl, 2-furoyl, 2-thiophenecarbonyl, 2-pyridinecarbonyl, quinaldyl, trimellitoyl, (alkoxycarbonyl)methyl, (tert-butoxycarbonyl)-methyl, α-(alkoxycarbonypethyl, α-(alkoxycarbonyl)-α-methylethyl, C₄₋₁₀ aroylmethyl, tert-butoxycarbonyl (Boc), 9-fluorenylmethoxycarbonyl (Fmoc), (iso) menthoxycarbonyl, (di)alkyl-carbamoyl, N,N-alkylenecarbamoyl, N-pyrrolidinecarbonyl, carbazol-9-carbonyl, (N,N-dialkylcarbamoyl)methyl, (N,N-alkylenecarbamoyl)methyl, mesyl, tresyl, C₁₋₉ perfluoroalkanesulfonyl, benzenesulfonyl, pentafluorobenzenesulfonyl, p-toluenesulfonyl, 2-mesitylenesulfonyl, pentamethylbenzenesulfonyl, 2,4,6-triisopropylbenzenesulfonyl, 1-naphthalenesulfonyl, 2-naphthalenesulfonyl, 2-(methylsulfonyl)benzenesulfonyl, 8-quinolinesulfonyl, 2-thiophenesulfonyl, 4-methoxy-2,3,6-trimethylbenzenesulfonyl, α-toluenesulfonyl, o-anisolesulfonyl, 10-camphosulfonyl, (di)alkylsulfamoyl, N,N-alkylenesulfamoyl, triethylsilyl, triisopropylsilyl, triphenylsilyl, tert-butyl(dimethyl)silyl, dimethyl(isopropyl)silyl, cyclohexyl(dimethyl)silyl, dimethyl(phenyl)silyl, diisopropyl(methyl)silyl, 1,3,2-benzodioxaphosphole, 1,3,2-benzodioxaphosphole-2-oxide, 2,2′-ethylidene-bis(4,6-di-tert-butylphenoxy)phosphino, (1,1′-binaphthyl-2,2′-dioxy)phosphino, (1,1′-binaphthyl-2,2′-dioxy)phosphino-oxide, (1,1′-binaphthyl-3,3′-di(methylsilyl)-2,2′-dioxy)phosphino, di(menthoxy)phosphino, diisopropoxyphosphino, 4,5-diphenyl-1,3,2-dioxaphospholidine, diisopropylphosphino-oxide, diphenoxyphosphino, diphenylphosphino-oxide; OR⁰⁵ represents also a group of formula (Ia) as defined in claim 1,
R⁰¹ represents a Cl, a methoxy, 2,2,2,-trifluoroethoxy, N- or O-ephedrino, N- or O-prolinolo, a C₅₋₁₄ aryloxy, methyl, ethyl, propyl, isopropyl, butyl, sec-butyl, tert-butyl, cyclohexyl, phenyl, 1-naphthyl, 2-naphthyl, 2,3-dimethylphenyl, 3,5-dimethylphenyl, 5,6,7,8-tetrahydro-1-naphthyl, m- or p-anisyl, (trifluoromethyl)phenyl, 3,5-bis(trifluoromethyl)phenyl, pentafluorophenyl, trimethylsilylmethyl,
R⁰² represents a C₁₋₁₈ alkyl, C₅₋₇ cycloalkyl, C₄₋₁₀ aryl or heteroaryl, optionally substituted by one or several alkyl, alkoxy, aryl groups and/or heteroatoms such as O, N, Si, P, halogen; R⁰² represents also a vinyl; in the particular case where R⁰² may represent an alkoxy group, R⁰¹ and R⁰² are linked to each other and form an aminoalkoxy chain as ephedrino, prolinolo, or also R⁰² represents a skeleton of general formula (I′) as defined previously wherein:
P′* and P* atoms have identical absolute configurations; R⁰¹′ and R⁰¹ are identical,
(CR⁰³′R⁰⁴′)_{n′} and (CR⁰³R⁰⁴)ₙ are identical; Z′ and Z are identical; Ar′ and Ar are identical,
Q represents a CH₂, (CH₂)₂, (CH₂)₃, (CH₂)₄, (—CH₂)₂—SiMe₂, (—CH₂)₂SiBn₂, (—CH₂)₂SiPh₂, 1,2-phenylene, ferrocene-1,1′-diyl.

3) Compounds according to claim 1 characterized by:
an enantiomeric excess (ee) at least 95%,
m≧2, the P* and P′* atoms have the same absolute configuration,
Ar represents a benzene, naphthalene, pyrrole, indole, indoline, 2-methyl-indole, optionally substituted as defined in claim 1,
R⁰¹, R⁰², R⁰¹′, (CR⁰³R⁰⁴′)_{n′}, (CR⁰³R⁰⁴)ₙ, Ar′, and Q are as defined in claim 2.

4) Compounds according to claim 2 characterized by:
E and E′ are identical,
Z—(CR⁰³R⁰⁴)ₙ—Ar represents a 2-R⁰⁵O-phenyl, 1-R⁰⁵O-naphth-2-yl, 2-R⁰⁵O-naphth-1-yl, 8-R⁰⁵O-naphth-1-yl,
Q represents a CH₂, (CH₂)₂, (CH₂)₃, (CH₂)₄, (—CH₂)₂SiMe₂, ferrocene-1,1′-diyl.

5) Compounds according to any of claims 1, 2 and 4, characterized by m=1, n=0 and OR⁰⁵ represents as defined in claim 1 or 2.

6) Compounds according to any of claims 1 to 5 characterized by R⁰⁵, R⁰⁶ and/or R⁰⁷ of OR⁰⁵, SR⁰⁵, SO₂R⁰⁵, N(R⁰⁶R⁰⁷) and C(O)N(R⁰⁶R⁰⁷), possessing 2 to 3 carbon atoms either on the carbon atom directly linked to O, S or N, or on the carbon atom directly linked to the function which modifies O, S or N, and that N—(R⁰⁵) is a 1-naphthyl optionally substituted or a tert-butoxycarbonyl.

7) Compounds according to any of claims 1 to 6 characterized by (z), (z′), (z⁰¹), (z⁰²), (z⁰³) and (z⁰⁴) bonds terminated by an oxygen or nitrogen atom.

8) Compounds according to any of claims 1 to 7 characterized by R⁰² representing a vinyl or a C₁₋₂ alkylene terminated by an O, N, P or Si atom.

9) Compounds according to any of claims 1 to 8 characterized by R⁰¹ representing a group as defined in claim 2, linked to P* ou P′* atom by a carbon atom.

10) Metal-phosphine complexes useful to perform asymmetric syntheses in organic chemistry based on a transition metal and as ligand of the metal, at least an optically active form of a compound of general formula (I) as defined in any of claims 1 to 9, characterized in that they possess the general formula (III),
MₚL_{q}(X′)ᵣ(Sᵥ)ₛ(Sᵥ′)_{s′}Hₜ (III)
wherein
M represents a transition metal chosen among rhodium, ruthenium, iridium, cobalt, palladium, platinum, nickel or copper,
L represents an optically active compound of general formula (I) as defined previously in any of claims 1 to 9, wherein E and/or E′ represent 2e⁻, and E and/or E⁰¹ represent 2e⁻,
when the complex is cationic, X′ represents an anionic coordinating ligand such as halide ions Cl, Br or I, an anionic group such as OTf, BF₄, ClO₄, PF₆, SbF₆, BPh₄, B(C₆F₅)₄, B(3,5-di-CF₃—C₆H₃)₄, p-TsO, OAc, or CF₃CO₂ or also π-allyl, 2-methylallyl, and when the complex is anionic, X′ represents a cation such as Li, Na, K, unsubstituted or alkyl substituted ammonium,
Sᵥ and Sᵥ′ represent independently from one another, a ligand molecule such as H₂O, MeOH, EtOH, amine, 1,2-diamine (chiral or not), pyridine, a ketone as acetone, an ether as THF, a sulfoxide as DMSO, an amide as DMF or N-methylpyrrolidinone, an olefin as ethylene, 1,3-butadiene, cyclohexadiene, 1,5-cyclooctadiene, 2,5-norbornadiene, 1,3,5-cyclooctatriene, or an unsaturated substrate, a nitrile as acetonitrile, benzonitrile, an arene or C₅₋₁₂ eta-aryl optionally substituted by one or several C₁₋₅ alkyls, iso- or tert-alkyls, as benzene, p-cymene, hexamethylbenzene, pentamethylcyclopentadienyl,
H represents a hydrogen atom,
p is a number equal to 1 or 2; q is an integer varying from 1 to 4; r is an integer varying from 0 to 4; s and s′ independently from one another are integers varying from 0 to 2; t is an integer varying from 0 to 2.

11) Complexes according to previous claim characterized in that M represents rhodium, ruthenium, or iridium, and the ligand L represents a compound of general formula (I) as defined in any of claims 1 to 9, with R⁰¹ and R⁰² are as defined in claim 2, linked to P* or P′* atom by a carbon atom, and E, E′ and E⁰¹ represent 2e⁻.

12) Use of a compound as defined in any of claims 1 to 11 for the preparation of metal- phosphine catalysts useful to perform asymmetric syntheses in organic chemistry.

13) Use of a compound as defined in any of claims 1 to 11 characterized in that one transforms asymmetrically and catalytically C═C, C═O or C═N bonds of unsaturated substrates optionally bearing at least a chiral center, by hydrogenation, transfer hydrogenation, hydrosilylation, hydroboration, hydroformylation, isomerization of olefins, hydrocyanation, hydrocarboxylation, or electrophilic allylation.

14) Use according to previous claim characterized in that one reduces asymmetrically and catalytically C═C, C═O or C═N bonds by hydrogenation, transfer hydrogenation, hydrosilylation, or hydroboration, derivatives of alkylidene glycine optionally substituted, α- and/or β-substituted maleic acid derivatives, alkylidene succinic acid derivatives, α- and/or β-substituted cinnamic or acrylic acid derivatives, derivatives of ethylene, enamides, enamines, enols, enol ethers, enol esters, allylic alcohols, prochiral ketones optionally substituted and/or α-unsaturated, α- or β-ketoacid derivatives, diketones and derivatives, prochiral imine derivatives, oximes, also their salts, mono/di -esters or -amides, and substituted derivatives of the mentioned substrates.
